(19) United States
(12) Patent Application Publication
(10) Pub. No.: US 2024/0080708 A1
(43) Pub. Date: Mar. 7, 2024

(54) METHODS AND APPARATUS FOR SUPPORTING DIFFERENTIATED QUALITY OF SERVICE IN SIDELINK RELAYS

(71) Applicant: InterDigital Patent Holdings, Inc., Wilmington, DE (US)

(72) Inventors: Jaya Rao, Montreal (CA); Martino Freda, Laval (CA); Oumer Teyeb, Montreal (CA); Tuong Hoang, Montreal (CA)

(21) Appl. No.: 18/271,981

(22) PCT Filed: Jan. 11, 2022
(86) PCT No.: PCT/US2022/011990

§ 371 Date: Jul. 12, 2023

Related U.S. Application Data
(60) Provisional application No. 63/136,455, filed on Jan. 12, 2021.
(60) Provisional application No. 63/249,654, filed on Sep. 29, 2021.

(51) Int. Cl. H04W 28/02; H04W 72/566; H04W 76/14

(52) U.S. Cl. CPC H04W 28/0268; H04W 72/569; H04W 76/14; H04W 88/04

(57) ABSTRACT

The disclosure pertains to methods, apparatuses, systems, and/or procedures for supporting differentiated quality of service (QoS) in sidelink (SL) relays in wireless communications. In one embodiment, a method implemented in a relay Wireless Transmit/Receive Unit (WTRU), the relay WTRU to relay data from a plurality of remote WTRUs using a first forwarding configuration, comprises: receiving, from a remote WTRU of the plurality of remote WTRUs, via a device-to-device link, information indicating a priority value associated with the device-to-device link; receiving data from the remote WTRU of the plurality of remote WTRUs via the device-to-device link; determining a second forwarding configuration based on any of: the received priority value, the first forwarding configuration, and a priority threshold value associated with the device-to-device link; and transmitting the data received from the remote WTRU of the plurality of remote WTRUs, using the determined second forwarding configuration

### CROSS-REFERENCE TO RELATED APPLICATIONS

The application claims the benefit of priority to U.S. Provisional Patent Application Ser. No. 63/136455, filed Jan. 12, 2021, and U.S. Provisional Patent Application Ser. No. 63/249654, filed Sep. 29, 2021, the contents of each of which is incorporated herein by reference.

### SUMMARY

This disclosure pertains to methods and apparatus for performing wireless communications. For example, one or more embodiments disclosed herein are related to methods, apparatuses, systems, and/or procedures for supporting differentiated quality of service (QoS) in sidelink (SL) relays in wireless communications.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to one or more embodiments;

FIG. 1C is a system diagram illustrating an example radio access network (RAN) and an example core network (CN) that may be used within the communications system illustrated in FIG. 1A according to one or more embodiments;

FIG. 1D is a system diagram illustrating a further example RAN and a further example CN that may be used within the communications system illustrated in FIG. 1A according to one or more embodiments;

FIG. 2A is a block diagram illustrating a user plane radio protocol stack according to one or more embodiments;

FIG. 2B is a block diagram illustrating a control plane radio protocol stack according to one or more embodiments;

FIG. 3 is a block diagram illustrating weighted mapping according to one or more embodiments;

FIG. 4 is a flowchart illustrating an exemplary procedure for determining and applying a forwarding configuration at the adaptation layer in accordance with one or more embodiments;

FIG. 5 is a flow diagram illustrating a method of wireless communications implemented at a relay WTRU according to one or more embodiments;

FIG. 6 is a further flow diagram illustrating a method of wireless communications implemented at a relay WTRU according to one or more embodiments; and

FIG. 7 is a further flow diagram illustrating a method of wireless communications implemented at a relay WTRU according to one or more embodiments.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Networks for Implementation of Embodiments

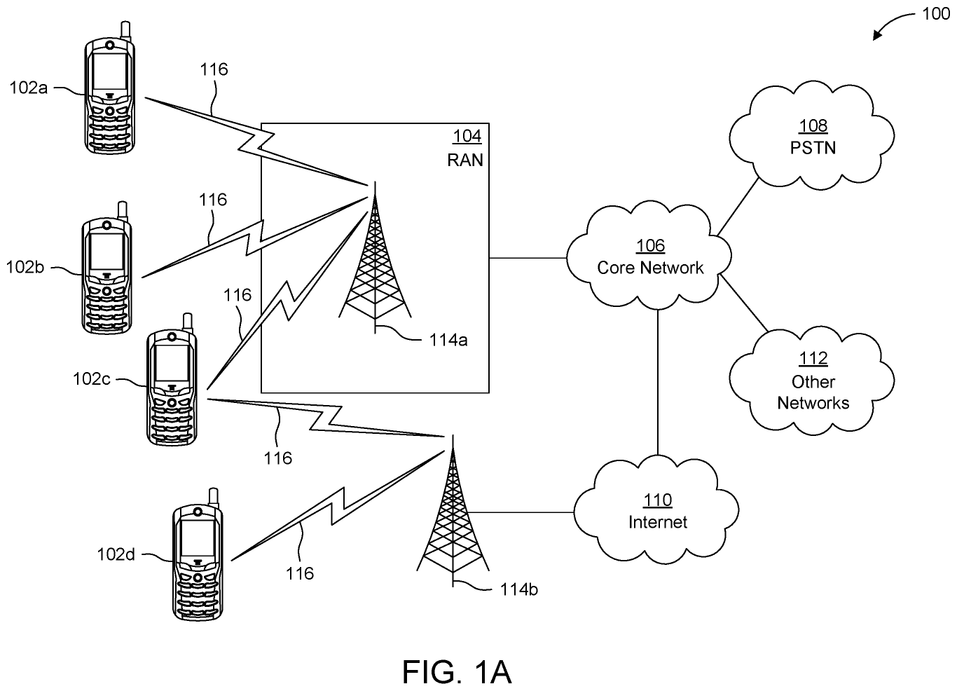

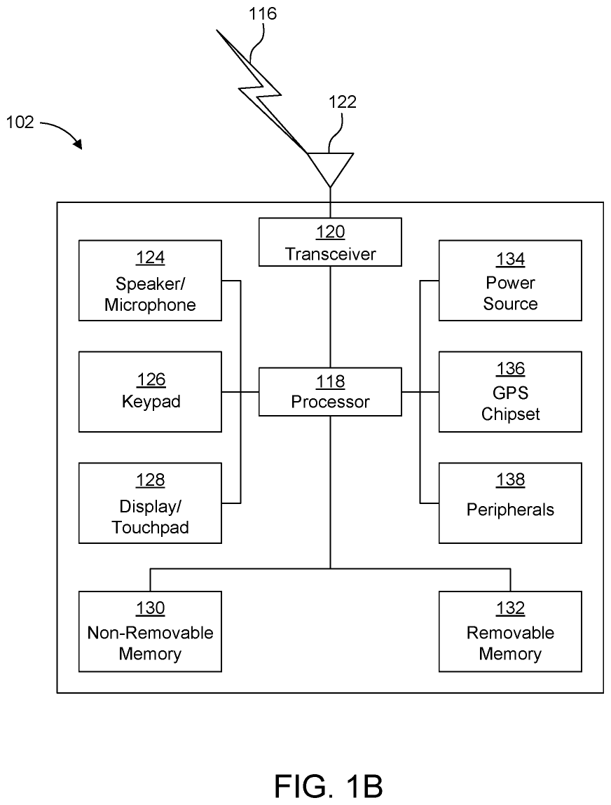

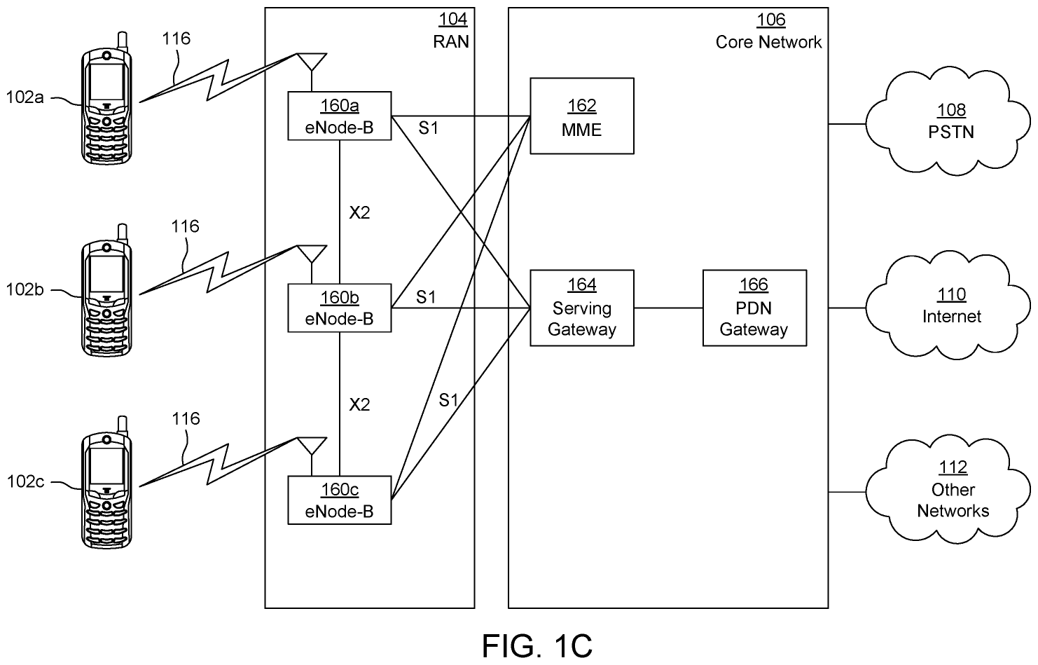

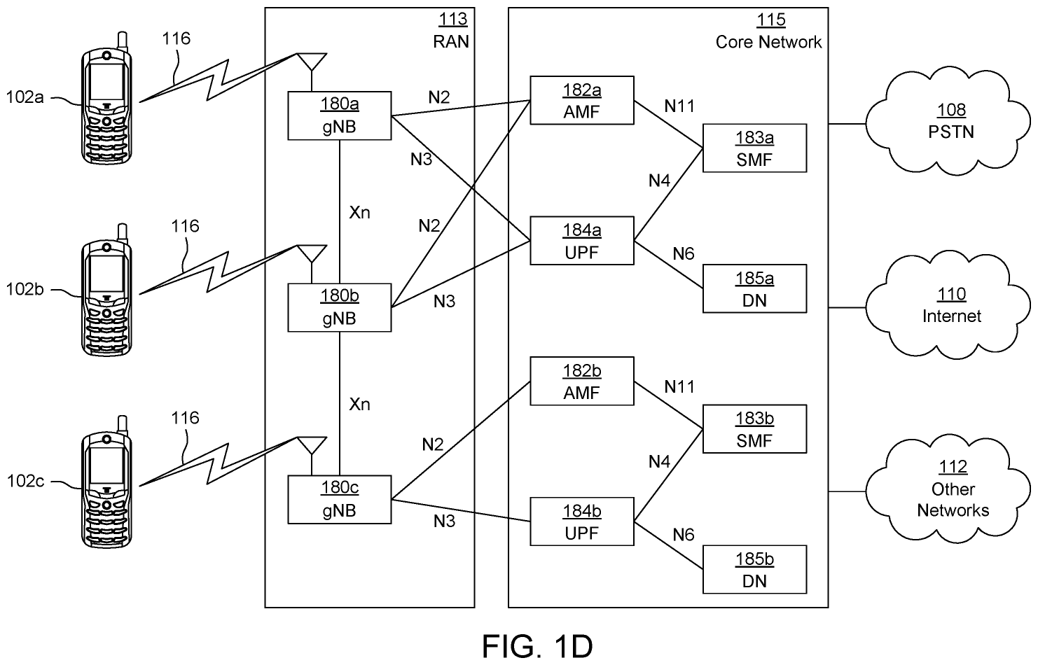

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include WTRUs 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114av may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA 2000, CDMA 2000 1X, CDMA 2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz.

The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180aand gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Supporting Differentiated Quality of Service (QoS) in Sidelink (SL) Relays

### 1. Sidelink Relay in Legacy Systems

3GPP Release 17 study on NR sidelink relay may include study the use of both WTRU to network relays and WTRU to WTRU relays based on PC5 (sidelink). Specifically, based on study item justification/objectives, a first version of NR sidelink has been developed for Release 16 and it solely focuses on supporting vehicle to everything (V2X) related road safety services. The design aims to provide support for broadcast, groupcast and unicast communications in both out-of-coverage and in-network coverage scenarios. On top of that, sidelink-based relaying functionality should be additionally studied in order for sidelink/network coverage extension and power efficiency improvement, considering wider range of applications and services.

To further explore coverage extension for sidelink-based communication, WTRU-to-network coverage extension and WTRU-to-WTRU coverage extension may be used (e.g., needed). Regarding WTRU-to-network coverage extension, next hop (Uu) coverage reachability may be necessary for WTRUs to reach a server in a PDN network or counterpart WTRU out of a proximity area. However, a release-13 solution on WTRU-to-network relay may be limited to evolved universal terrestrial radio access (EUTRA)-based technology, and thus may not be applied to NR-based systems, for both NG-RAN and NR-based sidelink communication. Regarding WTRU-to-WTRU coverage extension, proximity reachability currently may be limited to single-hop sidelink link, either via EUTRA-based or NR-based sidelink technology. However, that may be not sufficient in the scenario where there is no Uu coverage, considering the limited single-hop sidelink coverage. Overall, sidelink connectivity should be further extended in the NR framework, in order to support the enhanced QoS requirements. Accordingly, the detailed objectives of Rel-17 study item may entail studying single hop NR sidelink relays. For example, objects of study may include mechanism(s) with minimum specification impact to support the systems aspects (SA) requirements for sidelink-based WTRU-to-network and WTRU-to-WTRU relay, focusing on numerous aspects (if applicable) for layer-3 relay and layer-2 relay [RAN 2]. Such aspects may entail relay (re-) selection criterion and procedure, relay/remote WTRU authorization, QoS for relaying functionality, and service continuity. Such aspects may also entail security of relayed connection after SA3 has provided its conclusions, impact on user plane protocol stack and control plane procedure, e.g., connection management of relayed connection, and study of mechanism(s) to support upper layer operations of discovery model/procedure for sidelink relaying, assuming no new physical layer channel/signal [RAN 2].

The study shall take into account further input from SA working groups (WGs), e.g., SA WG2 (SA2) and SA WG3 (SA3), for these aspects (if applicable). WTRU-to-network relay and WTRU-to-WTRU relay may use the same relaying solution. Also, forward compatibility for multi-hop relay support in a future release may be taken into account. Further, for layer-2 WTRU-to-network relay, the architecture of end-to-end packet data convergence protocol (PDCP) and hop-by-hop radio link control (RLC), e.g., as recommended in TR 36.746, may be taken as a starting point.

### 1.1. WTRU to Network Relays in Rel-13

Relaying via proximity services (ProSe) WTRU to Network relays was introduced in Rel-13 to extend network coverage to an out of coverage WTRU by using PC 5 device to device (D2D) between an out of coverage WTRU and a WTRU-to-Network relay, for example, as described in the stage 2 specifications of 3GPP TS 36.300, as follows: a ProSe WTRU-to-Network Relay may provide a generic L3 forwarding function that can relay any type of IP traffic between the Remote WTRU and the network. One-to-one and one-to-many sidelink communications may be used between the Remote WTRU(s) and the ProSe WTRU-to-Network Relay. For both Remote WTRU and Relay WTRU (e.g., only) one single carrier (e.g., Public Safety ProSe Carrier) operation may be supported (e.g., Uu and PC5 should be same carrier for Relay/Remote WTRU). The Remote WTRU may be authorized by upper layers and can be in-coverage of the Public Safety ProSe Carrier or out-of-coverage on any supported carriers including Public Safety ProSe Carrier for WTRU-to-Network Relay discovery, (re)selection and communication. The ProSe WTRU-to-Network Relay may be (e.g., always) in-coverage of EUTRAN. The ProSe WTRU-to-Network Relay and/or the Remote WTRU may perform sidelink communication and/or sidelink discovery, for example, as described in, for example, section 23.10 and 23.11 respectively.

### 1.2. Relay Selection for WTRU to Network (NW) Relays

Relay selection/reselection for ProSe WTRU to NW relays is performed based on a combination of access stratum (AS) layer quality measurements (RSRP) and upper layer criteria. This procedure is described in more detail, for example, in the stage 2 specifications of 3GPP TS 36.300, as follows:

The eNB may control whether the WTRU can act as a ProSe WTRU-to-Network Relay:
If the eNB broadcasts any information associated with ProSe WTRU-to-Network Relay operation, in such a case ProSe WTRU-to-Network Relay operation may be supported in the cell.
The eNB may provide any of:
transmission resources for ProSe WTRU-to-Network Relay discovery using broadcast signalling for an idle state (for example, RRC_IDLE state) and dedicated signalling for a connected state (for example RRC_CONNECTED state); and
reception resources for ProSe WTRU-to-Network Relay discovery using broadcast signalling.
The eNB may broadcast a minimum and/or a maximum Uu link quality (RSRP) threshold(s) that the ProSe WTRU-to-Network Relay may (e.g., need to) respect before it can initiate a WTRU-to-Network Relay discovery procedure. In idle state (e.g., RR_IDLE state), in a case where (e.g., when) the eNB broadcasts transmission resource pools, the WTRU may use the threshold(s) to autonomously start or stop the WTRU-to-Network Relay discovery procedure. In connected state (e.g., RRC_CONNECTED state), the WTRU may use the threshold(s) to determine if it can indicate to eNB that it is a Relay WTRU and may want to start ProSe WTRU-to-Network Relay discovery.

If the eNB does not broadcast transmission resource pools for ProSe-WTRU-to-Network Relay discovery, in such a case a WTRU may initiate a request for ProSe-WTRU-to-Network Relay discovery resources by dedicated signalling, respecting these broadcasted threshold(s).

If the ProSe-WTRU-to-Network Relay is initiated by broadcast signalling, it can perform ProSe WTRU-to-Network Relay discovery in a case where (e.g., when) in idle state (e.g., RRC_IDLE state). If the ProSe WTRU-to-Network Relay is initiated by dedicated signalling, it can perform relay discovery, for example, as long as it is in connected state (e.g., RRC_CONNECTED state).

A ProSe WTRU-to-Network Relay performing sidelink communication for ProSe WTRU-to-Network Relay operation may (e.g., has to) be in connected state (e.g., RRC_CONNECTED state). After receiving a layer- 2 link establishment request or TMGI monitoring request (upper layer message) from the Remote WTRU, the ProSe WTRU-to-Network Relay may indicate to the eNB that it is a ProSe WTRU-to-Network Relay and/or may intend to perform ProSe WTRU-to-Network Relay sidelink communication. The eNB may provide resources for ProSe WTRU-to-Network Relay communication.

The remote WTRU can decide when to start monitoring for ProSe WTRU-to-Network Relay discovery. The Remote WTRU can transmit ProSe WTRU-to-Network Relay discovery solicitation messages while in idle state (e.g., RRC_IDLE state) or in connected state (e.g., RRC_CONNECTED state) depending on the configuration of resources for ProSe WTRU-to-Network Network Relay discovery. The eNB may broadcast a threshold, which is, for example, used by the Remote WTRU to determine if it can transmit ProSe WTRU-to-Network Relay discovery solicitation messages, to connect or communicate with ProSe WTRU-to-Network Relay WTRU. The connected state (e.g., RRC_CONNECTED state) Remote WTRU, may use the broadcasted threshold to determine if it can indicate to eNB that it is a Remote WTRU and/or may want to participate in ProSe WTRU-to-Network Relay discovery and/or communication. The eNB may provide, transmission resources using broadcast or dedicated signaling and reception resources using broadcast signaling for ProSe WTRU-to-Network Relay Operation. The Remote WTRU may stop using ProSe WTRU-to-Network Relay discovery and/or communication resources in a case where (e.g., when), for example, RSRP goes above the broadcasted threshold. (E.g., exact) Time of traffic switching from Uu to PC5 or vice versa may be up to higher layer.

The Remote WTRU may perform radio measurements at PC5 interface and/or may use them for ProSe WTRU-to-Network Relay selection and/or reselection along with higher layer criterion. A ProSe WTRU-to-Network Relay may be considered suitable in terms of radio criteria if the PC5 link quality exceeds configured threshold (pre-configured or provided by eNB). The Remote WTRU may select the ProSe WTRU-to-Network Relay, which satisfies higher layer criterion and/or has best PC5 link quality among all suitable ProSe WTRU-to-Network Relays.

The Remote WTRU may trigger ProSe WTRU-to-Network Relay reselection in a case where (e.g., when) any of:
PC5 signal strength of current ProSe WTRU-to-Network Relay is below configured signal strength threshold; and
it receives a layer-2 link release message (upper layer message) from ProSe WTRU-to-Network Relay.

### 1.3. WTRU to Network Relays for Wearables

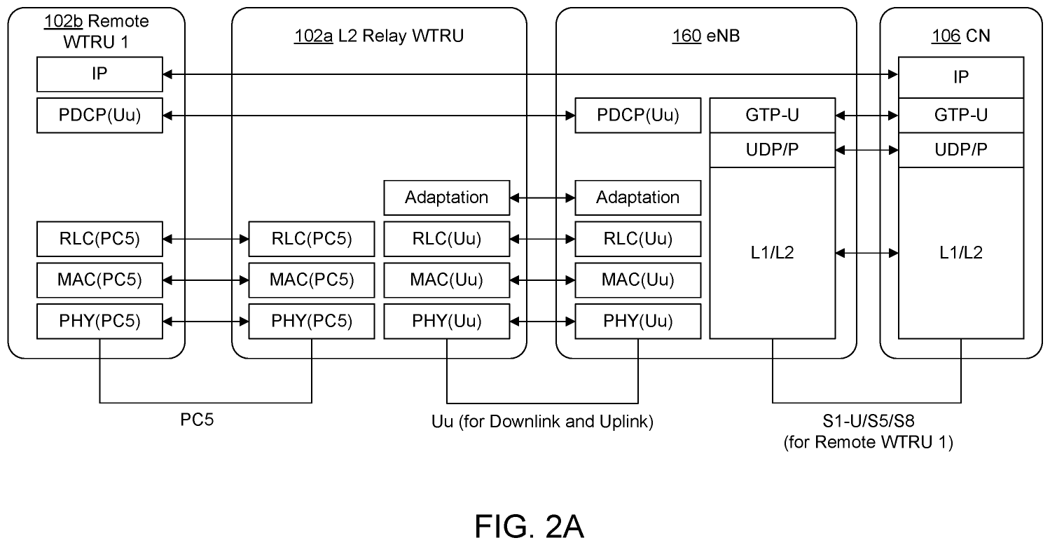

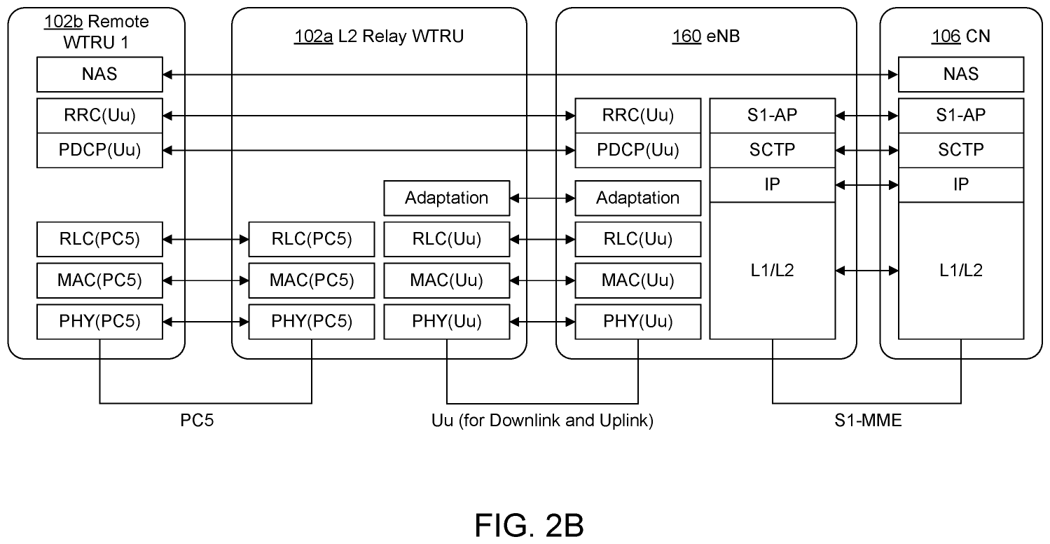

In release 14, a study for WTRU to NW relays for commercial use cases tailored to wearables and IoT devices was performed in RAN 104/113. While such study did not result in any specification, a technical report (TR) provided some preferred solutions for such relays. For example, contrary to ProSe WTRU to NW relays, which use a L3 (IP layer) relaying approach, the WTRU to NW relays for wearables may be (e.g., was expected to be) a L2 relay based on protocol stacks shown in FIG. 2A and FIG. 2B. For example, FIG. 2A depicts a user plane protocol stack for layer 2 evolved WTRU-to-Network relay (PC5). Additionally, FIG. 2B depicts a control plane radio stack for layer 2 evolved WTRU-to-Network relay.

### 1.4. Connection Establishment for Unicast Links in NR V2X

Relay solutions in previous releases of the LTE specification were based on a one-to-one communication link established at upper layers (ProSe layer) between two WTRUs (the remote WTRU and WTRU to NW relay). Such connection was transparent to the AS layer and connection management signaling and procedures performed at the upper layers are carried by AS layer data channels. The AS layer may be, in such a case, unaware of such a one-to-one connection.

In NR V2X (Rel16), the AS layer supports the notion of a unicast link between two WTRUs. Such unicast link may be initiated by upper layers (as in the ProSe one-to-one connection). The AS layer may be informed of the presence of such unicast link, and/or any data that may be transmitted in unicast fashion between the peer WTRUs. With such knowledge, the AS layer can support hybrid automatic repeat request (HARQ) feedback, channel quality indicator (CQI) feedback, and/or power control schemes which may be specific to unicast.

A unicast link at the AS layer may be supported via a PC5-radio resource control (RRC) connection. For example, in 3GPP TS 38.300, the PC5-RRC connection may be defined as follows: the PC5-RRC connection may be a logical connection between a pair of a Source Layer-2 ID and a Destination Layer-2 ID in the AS. One PC5-RRC connection may be corresponding to one PC5 unicast link. The PC5-RRC signalling, can be initiated after its corresponding PC5 unicast link establishment. The PC5-RRC connection and the corresponding sidelink Signaling Radio Bearers (SRBs) and sidelink Data Radio Bearers (DRBs) may be released in a case where (e.g., when) the PC5 unicast link is released as indicated by upper layers.

For any (e.g., each) PC5-RRC connection of unicast, one sidelink SRB may be used to transmit the PC5-S messages before the PC5-S security has been established. One sidelink SRB may be used to transmit the PC5-S messages to establish the PC5-S security. One sidelink SRB may be used to transmit the PC5-S messages after the PC5-S security has been established, which is protected. One sidelink SRB may be used to transmit the PC5-RRC signalling, which is protected and (e.g., only) sent after the PC5-S security has been established.

PC5-RRC signaling may include a sidelink configuration message (RRCReconfigurationSidelink) where one WTRU configures the receiver (RX)-related parameters of any (e.g., each) SL radio bearer (SLRB) in the peer WTRU. Such a reconfiguration message can configure the parameters of any (e.g., each) protocol in the L2 stack (service data adaptation protocol (SDAP), PDCP, etc.). The receiving WTRU can confirm or reject such configuration, depending on whether it can support the configuration suggested by the peer WTRU.

### 1.5. Bearer Mapping and QoS at the Adaptation Layer

According to embodiments, a relay WTRU 102a may be configured to perform 1:1, N:1 and/or 1:N mapping from any number of ingress RLC channels to any number of egress RLC channels for enabling flexible utilization of ingress/egress RLC channels and resources on different hops while satisfying the end-to-end (E2E) QoS. An RLC channel may comprise (e.g., consist of) the RLC, MAC and physical (PHY) sublayers, where any (e.g., each) sublayer may be, respectively, associated with any number of RLC, MAC and PHY configurations and entities, for example. According to embodiments, a relay WTRU 102a configured to perform L2 relaying may also be configured with an adaptation layer for performing the 1:1, N:1 and/or 1:N mapping from the ingress RLC channel(s) to egress RLC channel(s). The different ingress RLC channels may carry PDUs originating either from the same remote WTRU 102b or different remote WTRUs 102b.

In the case of WTRU-to-network relaying, the ingress RLC channels on PC5 link may be associated with any number of end-to-end (E2E) radio bearers, which carry PDUs between a remote WTRU 102b and network via a relay WTRU 102a. At the relay WTRU 102a, the egress RLC channels on the Uu link carry the PDUs between the relay WTRU 102a and a RAN node 104/113 (e.g. gNB 180).

In the case of a WTRU-to-WTRU relaying, the ingress PC5 RLC channels may be associated with any number of end-to-end SL radio bearers (SLRBs), which carry PDUs from a source remote WTRU 102b to a destination remote WTRU 102c via relay WTRU 102a. At the relay WTRU 102a, the egress RLC channels on the next-hop PC5 link carry the PDUs from the relay WTRU 102a to destination remote WTRU 102c and/or another relay WTRU 102a.

A similar 1:1, N:1 and 1:N mapping between ingress RLC channels and egress RLC channels may also be supported at an integrated access and backhaul (IAB) node for carrying PDUs i) between a WTRU 102 and a next-hop IAB node (e.g. distributed unit (DU) node) and/or a DU of a donor gNB 180 or ii) another IAB node (e.g. DU node) and a next-hop IAB node and/or a DU of a donor gNB 180.

The adaptation layer at the relay WTRU 102a may be configured in both WTRU-to-NW relaying and in WTRU-to-WTRU relaying deployments/scenarios. At the adaptation layer of the relay WTRU 102a, the PDUs carried by the any number of ingress RLC channels (receiving side of relay WTRU 102a) may be mapped to any number of egress PC5 RLC channels (transmitting side of relay WTRU 102a) in a case where (e.g., when) relaying to the intended destination (e.g. gNB 180 or destination remote WTRU 102c), for example. At the relay WTRU 102a, the PDUs received via any number of PC5 RLC channels may be multiplexed/demultiplexed at the adaptation layer of the relay WTRU 102a in a case where (e.g., when) mapping to the next-hop egress RLC channel (Uu or PC5), for example. In a case where (e.g., when) supporting 1:1 or N:1 mapping, the adaptation layer may be configured to multiplex the PDUs associated with any number of E2E radio bearers to a single egress RLC channel, for example. According to embodiments, in a case where (e.g., when) supporting 1:N mapping, the adaptation may be configured to demultiplex the PDUs associated with E2E radio bearers to any number of egress RLC channels (Uu or PC5).

The E2E radio bearers, originating from a remote WTRU 102b, may be carrying the PDUs corresponding to any number of QoS flows, where the different QoS flows may be mapped to any number of PC5 RLC channels at the remote WTRU 102b. The different QoS flows may differ in terms of the QoS flow identifier (QFI) and/or other QoS characteristics/parameters including, bitrate (e.g. guaranteed or best effort), latency and/or reliability, for example. Certain QoS parameters may be satisfied on both an end-to-end (E2E) basis and a hop-by-hop (H2H) basis (e.g. latency, reliability) whereas other parameters may be satisfied on either E2E or H2H basis. For satisfying the H2H QoS requirements, the different sublayers in a RLC channel (e.g. RLC, MAC and PHY) may be configured with different configuration parameters. Such configuration parameters may include support for acknowledged mode/unacknowledged mode (AM/UM) in RLC, logical channel prioritization (LCP) rules/restrictions and associated parameters (e.g. prioritized bit rate (PBR), bucket size duration (BSD), priority) at MAC and number of HARQ transmissions, for example. For E2E QoS requirements, it may be possible that certain parameters may be configured in the PDCP (e.g. sequence number size, robust header compression (ROHC)) and SDAP (e.g. mapping between QFI and radio bearers) sublayers, for example.

For the case of WTRU-to-NW relaying, the splitting of the E2E QoS requirements into H2H requirements/budgets may be performed by the gNB 180 based on the higher layer QoS parameters provided by the remote WTRU 102b and/or core network functions (e.g. AMF, SMF), for example. Alternatively, the splitting may be performed based on coordination between the remote WTRU 102b, relay WTRU 102a and/or gNB 180. In the case of WTRU-to-WTRU relaying, the splitting of E2E QoS requirements to H2H requirements may be performed by relay WTRU 102a and remote WTRU 102b based on higher layer configuration in a case where (e.g., when) the WTRUs are out of coverage. In the case when any number of WTRUs are in coverage, the splitting may be performed with the assistance of a gNB 180. For example, a QoS flow with an E2E latency requirement or E2E packet delay budget (PDB) may be split to a first PDB to be satisfied on the first hop (e.g. PC5 link) and second PDB to be satisfied on the second hop (e.g. Uu link). In a case where (e.g., upon) splitting the E2E QoS, for example, the configuration at different sublayers to satisfy/enforce the H2H QoS may be performed by remote/relay WTRU 102a and/or gNB 180 with RRC and/or PC5 signaling, for example.

In Rel 17 L2 WTRU-to-NW relays and WTRU-to-WTRU relays, mapping from N ingress RLC channels (includes RLC, MAC, PHY) to one egress RLC channel is supported at the adaptation layer of relay WTRU 102a. The mapping from N E2E radio bearers (includes SDAP, PDCP) to any number of egress RLC channels may also be supported at the adaptation layer at a remote WTRU 102b. For L2 WTRU-to-NW relays, the E2E QoS may be split by the gNB 180 and the RLC channels at a remote WTRU 102b and a relay WTRU 102a may be configured such that the split QoS may be achievable at any (e.g., each) hop. For WTRU-to-WTRU relays, the E2E QoS may be split based on higher layer configuration and correspondingly, the RLC channels at the remote WTRU 102b and the relay WTRU 102a may be configured such that the split QoS may be achievable at any (e.g., each) hop.

Due to different QoS performance (e.g. delays) experienced over the PC5 links (e.g. different congestion level over resource pools), the PDUs received at the relay WTRU 102a over different PC5 RLC channels may arrive at the relay WTRU 102a with a different remaining QoS margin (e.g. additional latency the PDUs can tolerate). In a case where (e.g., when) the relay performs N:1 mapping, the PDUs from different PC5 RLC channels are multiplexed into the same Uu buffer and are applied with the same configuration/treatment over the egress RLC channel (e.g. logical channel (LCH) priority, PBR) in the next hop Uu link. This may result in some PDUs not meeting the intended E2E QoS (e.g. those PDUs that were delayed over the PC5) while other PDUs may get more QoS than they require (e.g. those PDUs that arrived early over the PC5).

In this regard, the key challenge is on how to ensure E2E QoS (e.g. latency) in a case where (e.g., when) relaying PDUs belonging to different QoS flows over different PC5 RLC ingress channels from the same or different remote WTRU(s) and mapping/multiplexing to a single egress Uu RLC channel.

### 2. Mechanisms at Relay WTRU for Meeting Remaining QoS

The terms remaining QoS and residual QoS are henceforth used interchangeably to denote the remaining margin of a certain QoS metric in a case where (e.g., when) the PDU arrives at the relay WTRU 102a (e.g. the QoS to be achieved/enforced when transmitting in any number of next-hop links). For the case of DL, the remaining QoS is the QoS requirements/constraints that have to be fulfilled over the link between the relay WTRU 102a and the remote WTRU 102b, while for UL, it is the QoS requirements/constraints that have to be fulfilled over the link between the relay WTRU 102a and the gNB 180 (assuming a WTRU to NW relay scenario). For some metrics, the remaining QoS may be stricter than the E2E QoS metrics (e.g. remaining tolerable latency over the Uu link towards the gNB 180), while, for other metrics, the remaining QoS may be more relaxed than the E2E QoS metrics (e.g. if the PDUs have arrived at the relay WTRU 102a at a data rate higher than the E2E guaranteed bit rate (GBR) data rate, the remaining data rate QoS metric over the Uu link to the gNB 180 could be lower than the E2E GBR data rate). In some cases, the remaining QoS may be stricter or more relaxed than the per hop QoS metric being used. For example, if a PDU has arrived late at the relay WTRU 102a, having experienced more delay than the PC5 PDB, the remaining latency over the Uu link to the gNB 180 to satisfy the latency QoS requirement of the PDU will be lower than the PDB that was normally used for such PDUs over the Uu link. Alternatively, if a PDU arrives at the relay WTRU 102a well before the PC5 PDB, the remaining latency over the Uu link to the gNB 180 could be considered higher than the PDB that was normally used for such PDUs over the Uu link. To summarize, the remaining QoS may vary dynamically based on the QoS experienced in the first hop (e.g. i) PC5 link for UL, Uu link for the DL for WTRU-to-NW relaying and ii) PC5 links for WTRU-to-WTRU relaying), where, for a fixed E2E QoS (e.g. E2E latency, GBR) an increase/decrease in the QoS over the first hop link and/or relay WTRU 102a translates to decrease/increase in the remaining QoS over the next hop.

At the adaptation layer of the relay WTRU 102a, the PDUs corresponding to any number of QoS flows, with the same or different E2E and/or H2H QoS requirements, may be mapped to any number of egress RLC channels. The any number of egress RLC channels may be configured to achieve/enforce different H2H QoS in a case where (e.g., when) forwarding the PDUs in the next hop. In an example related to mapping at an adaptation layer of the relay WTRU 102a, the PDUs received in the ingress PC5 RLC channels may be stored in any number of ingress buffers associated with the ingress PC5 channel. Subsequently, the PDUs in the buffer may be mapped at the adaptation layer to any number of egress buffers associated with the egress RLC channels. In a case where (e.g., upon) mapping to the egress buffers, the configuration at the egress RLC channel for achieving/enforcing QoS in the next-hop may be applied to all PDUs in the egress buffer.

In this regard, it is possible that the PDUs received in the ingress RLC channels and stored in the ingress buffers may have different remaining or residual QoS to be satisfied in the subsequent hop(s). Based on the determination of the remaining QoS for the PDUs received in the different ingress RLC channels, the relay WTRU 102a may apply certain compensation mechanisms at the adaptation layer and/or egress RLC channels such that the remaining QoS for the PDUs may be satisfied.

### 2.1. Methods for supporting Differentiated QoS at Relay WTRU

A relay WTRU 102a may be configured with a condition associated with the treatment of data at the relay WTRU 102a if (e.g., upon) reception over an ingress RLC channel. Such condition may be related to or may reflect a remaining QoS to the concerned data if (e.g., upon)arrival at the relay WTRU 102a (e.g., considering the “expended QoS margin” over the ingress link) or a change of such remaining QoS. A relay WTRU 102a, based on such conditions described herein, may perform various actions.

According to embodiments, the relay WTRU 102a may select the egress RLC channel (or allowable/unallowable egress RLC channels) from its configured egress RLC channels which it can use to transmit data from an ingress RLC channel. A WTRU 102 may be configured with any number of egress RLC channels, and it may determine, for a specific ingress RLC channel, which egress RLC channel(s) to use and/or to prioritize for that ingress RLC channel. Such an embodiment is further referred to herein as determining the mapping or determining the mapping configuration.

According to embodiments, a relay WTRU 102a may be configured with any number of configurations (e.g. RLC, MAC, PHY) for a specific RLC channel. A relay WTRU 102a, in a case where (e.g., when) transmitting data on an egress RLC channel, may apply a specific configuration to that egress RLC channel depending on the condition. Under a first condition, a relay WTRU 102a may apply a first RLC channel configuration, while under a second condition, a relay WTRU 102a may apply a second RLC channel configuration. Such an embodiment is further referred herein as determining the RLC channel configuration for an RLC channel.

According to embodiments, a relay WTRU 102a may adapt the ordering of PDUs from any number of ingress RLC channels in a case where (e.g., when) putting/mapping them to an egress RLC channel based on a condition, for example, associated with the ingress RLC channel. Under a first condition, a relay WTRU 102a may apply a first ordering rule for the selection of PDUs from multiple ingress RLC channels to the egress RLC channel, while under a second condition, a relay WTRU 102a may apply a second ordering rule. Such an embodiment is further referred herein as determining the ordering of PDUs on an egress RLC channel.

According to embodiments, a relay WTRU 102a may send an indication to any number of remote WTRUs 102b for controlling the data transmission flow over the associated ingress PC5 RLC channels such that the E2E QoS requirements of the QoS flows may be met in a case where (e.g., when) performing the mapping/multiplexing at the adaptation layer of the relay WTRU 102a. Such an embodiment is further referred herein as Informing Remote WTRU for ensuring uniformity in QoS.

According to embodiments, a relay WTRU 102a may preemptively trigger a resource (re)selection, trigger a request for resource selection, or send an indication to a remote WTRU 102b based on such conditions described herein. Such an embodiment is further referred herein as Triggering Resource Request/Reselection in a case where (e.g., when) supporting mapping/multiplexing at adaptation layer.

According to embodiments, a relay WTRU 102a may perform any number of actions that may result in forwarding the PDUs from any number of ingress RLC channels (IRCs) associated with the receiving interface of relay WTRU 102a to at least one egress RLC channel (ERC) associated with the transmitting interface of the relay WTRU 102a based on any number of forwarding configurations. The receiving or transmitting interfaces of relay WTRU 102a may correspond to either SL interfaces or Uu interfaces depending on whether UL or DL transmissions are performed in the case of WTRU-to-NW relaying, for example. In the case of WTRU-to-WTRU relaying, the receiving and transmitting interfaces at the relay WTRU 102a may correspond to SL interfaces, for example. The relay WTRU 102a may apply a forwarding configuration at the adaptation layer of the relay WTRU 102a in a case where (e.g., when) forwarding/relaying the received PDUs to the next hop node (e.g., gNB 180 or remote WTRU) based on any number of conditions (described in the following sections), for example, related to satisfying the remaining QoS requirements in a case where (e.g., when) relaying, for example.

The categories of different actions and the associated actions that may be performed by the relay WTRU 102a in a case where (e.g., when) applying the forwarding configuration may include a combination of any number of the following:
Mapping
   Multiplexing/Demultiplexing:
      For example, the relay WTRU 102a may multiplex the PDUs from N IRCs to an ERC in a case where (e.g., when) performing N:1 mapping/multiplexing
      For example, the relay WTRU 102a may demultiplex the PDUs from an IRC to N ERCs in a case where (e.g., when) performing 1:N mapping/demultiplexing
      For example, the relay WTRU 102a may map/forward the PDUs from an IRC to an ERC in a case where (e.g., when) performing 1:1 mapping/forwarding
   Weighted mapping
      For example, the relay WTRU 102a may forward the PDUs from IRCs to ERCs using a weighing configuration comprising any number of weight values associated with the different IRCs and/or ERCs. The weighting configuration may be associated with the priority values associated/configured to the IRCs/ERCs, for example. In an example, consider a scenario where a relay WTRU 102a may use a first weight value for a first IRC and a second weight value for a second IRC, wherein the first weight value is greater than the second weight value. This scenario may result in the relay WTRU 102a selecting a higher number of PDUs from the first IRC compared to the PDUs in the second IRC, where, for example, the number of selected PDUs may be proportional to the associated weight values, in a case where (e.g., when) performing forwarding of the PDUs from IRCs to an ERC, for example. According to embodiments, the relay WTRU 102a may select the PDUs from the first IRC for a longer time duration compared to when selecting the PDUs in the second IRC, where, for example, the time duration applied may be proportional to the associated weight values, in a case where (e.g., when) performing forwarding of the PDUs from IRCs to an ERC, for example.
   Ordering
      For example, the relay WTRU 102a may forward the PDUs by using an ordering configuration/rule which may result in changing the order of the PDUs in a case where (e.g., when) forwarding/mapping from the IRCs to the ERCs. The relay WTRU 102a may change the ordering of the PDUs by changing the ordering configuration/rule based on any number of conditions (described in the following sections), for example
Scheduling
   QoS adaptation
      For example, the relay WTRU 102a may forward the PDUs received via IRCs by adapting/changing the QoS achievable in a case where (e.g., when) forwarding/relaying. For example, the relay WTRU 102a may adapt/change the QoS associated with IRC/ERC, for example, based on conditions related to remaining QoS, by changing any number of parameters/rules applied at the access stratum (AS) layer protocol stack (e.g., adaptation layer parameters, LCP rules, LCH parameters of IRC/ERC including priority, PRB, BSD. This may result in changing the (e.g., expected) data rate, latency, and/or reliability in a case where (e.g., when) forwarding/relaying the PDUs over the next hop.
      According to embodiments, the relay WTRU 102a may perform QoS adaptation by sending indication(s) to the remote WTRU 102b and/or gNB 180 to indicating how the transmission of data/PDUs associated with any number of QoS flows may be controlled. In such case, the relay WTRU 102a may send flow control indication(s) to remote WTRUs 102b and/or gNBs 180 for indicating whether to start, stop, change the data rate, etc., such that the desired QoS level (e.g., data rate, latency) may be achieved in a case where (e.g., when) buffering and/or forwarding the PDUs, for example.
   Resource request/(re)selection
      For example, the relay WTRU 102a may forward the PDUs received via IRCs by triggering and/or sending an indication to the network to request resources (e.g., by sending an SR/BSR/pre-emptive BSR in a case where (e.g., when) requesting for dynamic grant and/or an indication in a case where (e.g., when) requesting a configured grant) and/or perform resource (re)selection (e.g., when operating in Mode 2). The relay WTRU 102a may request resource grants and/or perform resource (re)selection based on detection of any number of conditions (described in following sections), for example, associated with remaining QoS, for example.
Routing
   For example, the relay WTRU 102a may perform forwarding by routing the PDUs from any number of IRCs to ERCs using a routing configuration. The routing configuration applied by the relay WTRU 102a may indicate how the different IRCs may be connected/mapped to ERCs. The relay WTRU 102a may switch between different routing configurations to apply based on detection of any number of conditions (described in following sections), for example, related to remaining QoS, for example.

Hereafter, references and/or terminologies related to mapping, multiplexing, demultiplexing, weighted mapping, ordering, scheduling, QoS adaptation, resource request, resource (re)selection, routing, etc. may refer to the one more actions applied by the relay WTRU 102a in a case where (e.g., when) performing forwarding of the PDUs, for example, using a forwarding configuration at the adaptation layer. References to mapping configuration at the adaptation layer and/or configurations applied at IRCs/ERCs (e.g. LCH/LCP parameters) may refer to the forwarding configuration and vice-versa.

The relay WTRU 102a may be configured with any number of conditions related to triggering one of the actions above. Such conditions may be related to the remaining QoS of the PDUs received in any number of ingress RLC channels for identifying to what extent the QoS on the first-hop PC5 link is met (e.g. latency experienced by the PDU so far) and/or whether to apply any of the embodiments described further herein (e.g. changing adaptation layer mapping configuration and/or egress RLC channel configuration) for meeting E2E QoS. Such conditions may dictate whether an action can/should be performed. Such conditions may dictate when (at what time instant) an action is performed (e.g. a condition/criterium is satisfied).

One type of condition related to the remaining QoS is an explicit indication/information from the network. For example, the relay WTRU 102a may receive from the gNB 180 the information on the remaining QoS for transmission over the Uu link (for the case of UL) and/or the remaining QoS for transmission over the PC5 link (for the case of DL). The information may be received semi-statically, during/if (e.g., upon) configuration of the E2E radio bearers between the remote WTRU 102b and gNB 180. The remaining QoS may be indicated to the relay WTRU 102a in a case where (e.g., when) configuring the adaptation layer mapping configuration and/or the egress RLC channels. The remaining QoS may be indicated on the basis of per-ingress RLC channel, per-egress RLC channel and/or per-ingress-to-egress mapping. For example, the gNB 180 may provide the remaining QoS (e.g. PDB) for an egress RLC channel configured on the Uu link to the relay WTRU 102a in a case where (e.g., upon) splitting the E2E QoS. In a case where (e.g., when) relaying in UL, the gNB 180 may provide the (e.g., expected) QoS over the Uu (e.g. per egress RLC channel) and the relay WTRU 102a may change the mapping configuration at the adaptation layer based on the received (e.g., expected) QoS, for example. In a case where (e.g., when) relaying in DL, the gNB 180 may indicate the remaining QoS (e.g. per ingress RLC channel) to the relay WTRU 102a, and the relay WTRU 102a may use the received information for changing the mapping configuration at the adaptation layer (e.g. to prioritize/deprioritize) in a case where (e.g., when) forwarding the PDUs over the egress RLC channels, for example.

Another example of an explicit indication is semi-static information. For example, the relay WTRU 102a may receive the semi-static information on remaining QoS from the (source) remote WTRU 102b from which the E2E radio bearers may be configured. The remaining QoS may be indicated to the relay WTRU 102a in a case where (e.g., upon) performing the E2E QoS splitting in the first and subsequent hop(s), for example. In a case where (e.g., when) relaying in UL, the remote WTRU 102b may estimate/measure the QoS expenditure over the PC5 link, and, based on the awareness of E2E QoS, the remote WTRU 102b may indicate the information on remaining QoS (e.g. per ingress) to the relay WTRU 102a for changing the mapping configuration at adaptation layer, for example.

Another example of an explicit indication is configuration information. For example, a relay WTRU 102a may receive a configuration parameter or message (e.g. RRC message, MAC control element (CE), etc.) which (e.g., explicitly/implicitly) indicates whether a condition, for example, related to remaining QoS, is satisfied. The relay WTRU 102a may derive the condition based on the received parameter and/or message. For example, a relay WTRU 102a may receive a message with a set of QoS levels, and may associate a first condition with the reception of any number of QoS levels, a second condition with the reception of any number of different QoS levels, etc. The relay WTRU 102a may perform any of the embodiments based on the received condition.

Another type of condition related to the remaining QoS can be based on buffer status and/or loading in at ingress/egress buffers and associated RLC channels. For example, such a condition may be associated with any number of measurements or combinations of measurements (e.g. compared to a threshold). Example measurements may include an amount of data in any number of RLC buffers, for example, over a period of time, and/or a rate of arrival/departure of packets in an RLC buffer. Additional example measurements may include an average, max, and/or min size of PDUs in an RLC buffer (e.g. number of PDUs in RLC buffer), and/or a measure of the amount of time spent by any number of PDUs in an RLC buffer. Further example measurements may include a number of RLC buffers meeting a condition associated with the amount of data, arrival rate, and/or PDU size.

Additional examples of conditions that can be based on buffer status and/or loading in at ingress/egress buffers and/or associated RLC channels may include changing the mapping configuration of an ingress RLC channel and/or changing the ordering of PDUs on the egress RLC channels. For example, a relay WTRU 102a may perform any of the actions described in the embodiments herein (e.g. change the mapping configuration of an ingress RLC channel) if at least one PDU in the RLC buffer for the ingress RLC channel is in the buffer for a period of time larger than a threshold. Alternatively or additionally, a relay WTRU 102a may perform any of the actions described in the embodiments herein (e.g. change the ordering of PDUs on the egress RLC channels) if the buffer status of an ingress RLC channel exceeds a threshold.

Another example of conditions that can be based on buffer status and/or loading in at ingress/egress buffers and/or associated RLC channels includes monitoring the ingress buffers and/or the egress buffers. For example, the relay WTRU 102a may monitor the ingress buffers associated with the ingress RLC channels for determining the remaining QoS. The monitoring may be performed by tracking the duration a PDU batch (e.g. any number of PDUs) has remained/stored in an ingress buffer. The batch may be considered to be delayed if the buffering duration exceed a configured threshold duration, which may be associated with the (e.g., expected) remaining QoS (e.g. QoS in the next-hop determined in a case where (e.g., upon) splitting of E2E QoS), for example. Additionally, other buffer status metrics that may be monitored for determining the remaining QoS may include the number of PDUs buffered which are above/below a configured threshold and/or the rate of PDU arrival/departure in the ingress buffer with respect to a configured arrival/departure rate, for example. Similar approach and/or metrics may also be applied by a relay WTRU 102a for monitoring the status at the egress buffers and/or for determining the remaining QoS. In the case of egress buffers, the relay WTRU 102a may also monitor the arrival/departure rate of its own traffic generated from the higher layers, which may be included in the egress buffers for transmission over the next-hop (Uu link or PC5 link). The relay WTRU 102a may in such a case determine or infer the remaining QoS for other relayed traffic (e.g. from other ingress buffers) based on monitoring of the QoS its own transmissions/traffic which may use the shared/common egress RLC channels, for example.

Another example of conditions that can be based on buffer status and loading in at ingress/egress buffers and associated RLC channels may include determination of numbers of PDUs received over time at any number of ingress buffers. For example, the relay WTRU 102a may determine the number of PDUs received in an ingress RLC channel over a time duration/window for determining whether the rate of PDUs received is within the range (e.g., expected) for the QoS in the first hop. The relay WTRU 102a may in such a case use a (configured) mapping function to determine the remaining QoS based on the achieved QoS in first hop PC5 link, for example.

Another type of condition related to the remaining QoS can be based on timing/timestamp information, for example, associated with any number of PDUs. For example, the relay WTRU 102a may track the timing related information (e.g. timestamp, marker or timing control PDU) in the received batch of PDUs for determining the delay incurred over the first-hop (PC5 link for UL, Uu link for DL). The timing information may in such a case be used for determining the remaining QoS, using a configured mapping function between the achieved first-hop QoS and the remaining QoS, and/or between the E2E QoS and achieved first-hop QoS for example. According to embodiments, the timing information may be indicated as a deadline/latency bound that may be satisfied on a per-hop and/or end-to-end basis. According to embodiments, the timing information may also be indicated on a count basis (e.g. hop-count).

Another example of conditions that can be based on timing/timestamp information relates to sending information on the remaining QoS. According to embodiments, the remote WTRU 102b may send the information on the remaining QoS, which may be determined by subtracting the (expected) first-hop QoS on PC5 link from the E2E QoS. For example, the remining delay available at the relay WTRU 102a for sending the PDUs may be determined (e.g., by the remote WTRU 102b) by subtracting the delay over the first-hop PC5 link (e.g. expected PDB over the PC5 link) from the E2E delay/PDB. The (e.g., expected) first hop QoS may be determined (e.g., by remote WTRU 102b) based on measurements made on the PC5 link and/or feedback (e.g. automatic repeat request (ARQ)/HARQ feedback) received from the relay WTRU 102a, for example.

Another type of condition related to the remaining QoS can be based on measurements on SL/Uu. For example, the relay WTRU 102a may perform measurements over the any number of SL resource pools associated with the ingress PC5 RLC channels for determining the remaining QoS. The channel related measurements may include any of: SL RSRP, SL-received signal strength indicator (RSSI), CQI and channel state information (CSI), and the load related measurements may include channel busy ratio (CBR) and channel occupancy ratio (CR), for example. Similarly, the relay WTRU 102a may perform measurements over the Uu link, e.g. corresponding to RSRP, RSSI, CQI and CSI, for determining the remaining QoS. The channel/load measurements made over a certain configured time duration may indicate whether the PDUs received over the resource pool are within the (e.g., expected) QoS range in the first-hop or have exceeded the QoS budget. The relay WTRU 102a may also determine the remaining QoS for a received batch of PDUs in the ingress buffer based on a (configured) mapping function between the SL channel/load measurements and/or remaining QoS and/or between the E2E QoS and channel/load measurements, for example.

Another example of conditions that can be based on measurements on SL/Uu relate to feedback messages and retransmissions. For example, the relay WTRU 102a may determine the SL conditions based on the number of ARQ/HARQ acknowledgement/non-acknowledgement (ACK/NACK) feedback messages and/or ARQ/HARQ retransmissions made over the any number of SL channels and/or resource pools associated with the ingress RLC channels. The remaining QoS may in such a case be determined based on a (configured) mapping function between the SL feedback/ReTx and remaining QoS, for example. As an example, a ReTx count above a threshold may translate to poor SL channel conditions, and hence, reduced remaining QoS.

Another type of condition related to the remaining QoS can be based on property associated with the remote WTRU 102b or link to which the RLC channel is associated. For example, a WTRU may be configured with a property specific to the remote WTRU 102b or a unicast link such as a WTRU/link priority and/or a configuration parameter enabling/disabling the specific action for the WTRU/link.

Another example of conditions that can be based on such a property or link relates to WTRU/link priority. For example, a WTRU/link configured with high priority may allow the relay WTRU 102a to change the mapping configuration of an RLC channel (with respect to an initial or default configuration). For example, the relay WTRU 102a may change the mapping configuration of a high priority WTRU/link as long as the impact to other WTRU/link mapping configuration is changed/impacted (e.g., only) for lower priority WTRUs/links.

Another type of condition related to the remaining QoS can be based on a QoS property associated with the RLC channel. For example, a WTRU may determine whether or not an action can be performed on an ingress RLC channel depending on a QoS-related parameter (e.g. priority value) configured with that RLC channel. Alternatively or additionally, the condition for when to perform an action (e.g. change of mapping) may depend on a QoS-related parameter (e.g. priority value) configured with that RLC channel.

Another type of condition related to the remaining QoS can be based on an indication (e.g. priority) received from a remote WTRU 102b in a previous-hop. For example, the relay WTRU 102a may receive a QoS related indication from the remote WTRU 102b over the ingress PC5 RLC channel (for the UL) or indication from the gNB 180 over the Uu link (for the DL), which may indicate whether the existing QoS budget in the first hop may be satisfied or a QoS related change may be necessary in the next-hop (e.g. Uu link or PC5 link) to compensate for inability for meeting the QoS budget in the first hop. According to embodiments, the QoS relayed indication may indicate a priority value associated with the ingress RLC channel. The use of the same/default priority value as per the RLC channel configuration may indicate the first-hop QoS is within the configured QoS budget (e.g. in a case where (e.g., upon) QoS splitting), whereas the use of a higher/lower priority value may indicate a request to compensate the QoS in the next hop, for example, due to the change in QoS in the first hop. The QoS related indication may be received from the remote WTRU 102b in the following a header of the PDU (e.g. adaptation layer header), a PC5-RRC message, a control PDU (e.g. from adaptation layer), and/or a SL MAC CE or sidelink control information (SCI). The relay WTRU 102a may ensure the remaining QoS is achievable in the next hop by changing the configuration at the adaptation layer and/or egress RLC channels based on a (configured) mapping function between the QoS indication (e.g. priority) and remaining QoS, for example.

Another type of condition related to the remaining QoS can be based on indications received from a next-hop node (e.g. gNB 180 or another relay/remote WTRU). For example, the relay WTRU 102a may determine the remaining QoS over the next-hop link (e.g. Uu link or PC5 link) either based on an explicit indication received from a gNB 180 and/or a next hop remote/relay WTRU 102a or implicitly based on monitoring of the next hop link. As an example, the gNB 180 and/or remote WTRU 102b may provide QoS status indications to the relay WTRU 102a, which may be sent dynamically based on event triggers (e.g. when a QoS budget is not met) or periodically. The status indication may be received by the relay WTRU 102a on per-E2E radio bearer, per-RLC channel, and/or any per-transmission basis, for example. According to embodiments, the relay WTRU 102a may monitor the channel/load conditions based on measurements (e.g. RSRP, CBR) and/or other transmissions/signaling (e.g. number of ARQ/HARQ retransmissions, ARQ/HARQ feedback, CSI reports) over any number of the channels directed to the same destination node (e.g. over Uu links or PC5 links) to determine/estimate the achievable remaining QoS.

Alternatively or in addition to the conditions related to the remaining QoS, the WTRU may perform actions based on the satisfaction of any number of triggering conditions for changing treatment of PDUs for fulfilling remaining QoS. According to embodiments, the relay WTRU 102a may be triggered to perform any number of actions for satisfying remaining QoS including (as described herein) i) changing the mapping at the adaptation layer or the selected egress RLC channel for an ingress RLC channel, ii) changing the configuration at egress RLC channels, iii) changing the ordering of the PDUs in a case where (e.g., when) putting the PDUs on an egress RLC channel, iv) triggering a resource (re)selection or requesting a resource, v) sending an indication to network and/or other relay/remote WTRU 102b, based on any number of triggering conditions for changing treatment of PDUs.

One type of triggering condition for changing treatment of PDUs can be an indication from a Network/remote WTRU 102b. For example, the relay WTRU 102a may be triggered to perform action(s) in a case where (e.g., when) receiving an indication from the network (e.g. in RRC, MAC CE, other control PDU or downlink control information (DCI), e.g. in WTRU-to-NW relaying). Similarly, the relay WTRU 102a may be triggered in a case where (e.g., when) receiving an indication from a remote WTRU 102b (e.g. in PC5-RRC, SL MAC CE, control PDU to SCI). In both scenarios, the indication received by the relay WTRU 102a may be for example, related to the change/update in configuration at the relay WTRU 102a and/or remaining QoS associated with the any number of QoS flows relayed via the relay WTRU 102a, for example. The relay WTRU 102a may send an indication to the (source) remote WTRU 102b in a case where (e.g., when) receiving another indication, for example, associated with change in configuration and/or remaining QoS, from the next-hop/destination remote WTRU 102c (e.g. in PC5-RRC, SL MAC CE or SCI, e.g. in WTRU-to-WTRU relaying).

Another type of triggering condition for changing treatment of PDUs can relate to loading at the relay WTRU 102a. For example, the relay WTRU 102a may be triggered to perform action(s) in a case where (e.g., when) the buffer level at the egress RLC channel(s) associated with the ingress PC5 RLC channel from the remote WTRU(s) is above a certain threshold value and/or remains above the threshold value for a certain time duration. The relay WTRU 102a may also be triggered for updating the adaptation layer mapping configuration in a case where (e.g., when) the buffer level at the ingress RLC channel is above a certain threshold and/or remains above the threshold for a time duration, for example. According to embodiments, the relay WTRU 102a may send an indication to remote WTRU/network in a case where (e.g., when) PDUs are dropped (e.g. at adaptation layer), for example, due to high loading and/or inability to meet remaining QoS.

Another type of triggering condition for changing treatment of PDUs can relate to change in adaptation layer configuration at a relay WTRU 102a. For example, the relay WTRU 102a may be triggered to perform action(s) in a case where (e.g., when) changing the mapping configuration at the adaptation layer, including changing the relative compensation factor (RCF)/priority values associated with ingress RLC channels, and/or changing the configuration of the egress RLC channels (e.g. priority, PDB, PBR).

Another type of triggering condition for changing treatment of PDUs can relate to channel/Loading conditions at a previous-hop and/or next hop link. For example, the relay WTRU 102a may be triggered to perform action(s) and/or send an indication to a network and/or remote WTRU 102b in a case where (e.g., when) channel measurements made (e.g. RSRP, RSSI, reference signal received quality (RSRQ), CQI, CSI) on the remote link (e.g. Uu link or PC5 link) increase/decrease, for example, with respect to a configured threshold and/or remain above/below a threshold for a certain time duration. The relay WTRU 102a may also be triggered in a case where (e.g., when) the load at the next-hop/previous-hop PC5 channel (e.g. CBR, CR) increases/decreases with respect to a configured threshold and/or remains above/below the threshold for a certain time duration.

Another type of triggering condition for changing treatment of PDUs can relate to change in QoS on a next hop/previous-hop link. For example, the relay WTRU 102a may be triggered to perform action(s) in a case where (e.g., when) any number of QoS related measurements (e.g., latency on the ingress/egress RLC channel over the previous/next hop) exceeds a certain threshold (e.g. PDB). The other measurements that may trigger an indication include in a case where (e.g., when) receiving ACK/NACK feedback for ARQ/HARQ, and/or number of ARQ/HARQ retransmissions exceed a threshold, for example. In the case of WTRU-to-NW relaying, the relay WTRU 102a may send an indication (e.g., to a network) in a case where (e.g., when) triggered by a QoS related measurement on the first-hop PC5 link. An indication may be sent to a remote WTRU 102b in a case where (e.g., when) triggered by a QoS related measurement on the Uu link. In the case of WTRU-to-WTRU relaying, the relay WTRU 102a may send an indication to a remote WTRU 102b in the next-hop/previous-hop in a case where (e.g., when) triggered by a QoS measurement in the previous-hop/next-hop, for example.

Another type of triggering condition for changing treatment of PDUs can relate to change in other configurations. For example, the relay WTRU 102a may be triggered to perform action(s) and/or send an indication to a network and/or a remote WTRU 102b in a case where (e.g., when) the discontinuous reception (DRX) configuration applied at the relay WTRU 102a is modified/updated, which may for example, impact the reception pattern and/or QoS achievable in the first-hop link at the ingress PC5 RLC channels. Additionally or alternatively, the relay WTRU 102a may send an indication (e.g., to a network) in a case where (e.g., when) other configurations related to the PC5 RLC channel between a remote WTRU 102b and the relay WTRU 102a is changed (e.g. HARQ is enabled/disabled on the PC5 link, resource pool used is changed).

The contents of the indication sent by the relay WTRU 102a to a network and/or any number of remote WTRU(s), in a case where (e.g., when) triggered by the above triggering conditions, may include various types of indications. For example, the sent indications may include any number of identifiers (IDs), and the relay WTRU 102a may send the IDs of any number of ingress PC5 RLC channels or egress RLC channels. Additionally, the sent indications may include timing information, and the relay WTRU 102a may send information on start/end timing and/or time duration with respect to a reference time slot for either suspending and/or resuming transmissions associated with an RLC channel (e.g. over PC5 link or Uu link). The sent indications may include information on QoS, and/or the relay WTRU 102a may indicate the determined/estimated remaining QoS (e.g. delay, throughput) and/or achievable/enforceable in the next-hop link (e.g. Uu link or PC5 link). The relay WTRU 102a may indicate the QoS type (e.g. GBR, non-GBR, best effort) of the traffic in the mapped ingress RLC channels at the adaptation layer.

Alternatively or additionally, the sent indications may include information on configuration of the ingress/egress RLC channel and/or adaptation layer. In such a case, the relay WTRU 102a may send to a remote WTRU 102b on any number of indication messages, such as a message for using of a different PC5 RLC channel, a message for changing configuration applied at the remote WTRU 102b (e.g. change priority applied at LCHs/PC5 RLC channels) and/or a message for changing the resource pool associated with the ingress RLC channel for transmitting the PDUs. In a case where (e.g., when) applying one of multiple preconfigured mapping configurations at adaptation layer, relay WTRU 102a may send the identity (ID) of the mapping in the indication.

Alternatively or additionally, the sent indications may include information on channel/load measurements, an indication for suspension/resumption, and/or an indication for changing the transmission rate. For example, relay WTRU 102a may send channel measurements (e.g. RSRP, RSSI, CSI) and/or load measurements (e.g. CBR, CR) to a network and/or a remote WTRU 102b. The relay WTRU 102a may transmit an Off/On for indicating suspension and/or resumption of transmission. Further the relay WTRU 102a may transmit an indication to increase/decrease rate of PDU transmission (e.g. number of PDUs per transmission instance/slot) by a certain indicated amount. Alternatively or additionally, the change may be indicated as a delta value with respect to an initial/default transmission rate.

The relay WTRU 102a may send the indication to the any number of remote WTRUs 102b and/or network in various ways. For example, the relay WTRU 102a may send the indication in RRC signaling (to network) and/or in PC5-RRC signaling (to remote WTRU 102b or another relay WTRU 102a). Additionally, the relay WTRU 102a may send an adaptation layer indication. For example, the indication may be included within the adaptation layer header, which may be appended to the PDUs prior to sending to lower layers in the RLC channel. Alternatively or additionally, the indication may be sent in an adaptation layer control PDU, which may be sent along with or separately with the PDUs. Alternatively or additionally, the indication may be sent in a flow control indication PDU and/or other control PDUs/markers.

The relay WTRU 102a may send the indication to the any number of remote WTRUs 102b and/or network in further ways. For example, the relay WTRU 102a may send the indication in a SL MAC CE (to a remote WTRU 102b or another relay WTRU 102a). Additionally, the relay WTRU 102a may send the indication in a SCI/physical SL control channel (PSCCH), in first stage and/or second stage SCI, and/or the WTRU may use a dedicated resource, e.g. physical SL feedback channel (PSFCH) (to remote WTRU 102b). Also, the relay WTRU 102a may send the indication in uplink control information (UCI)/physical UL control channel (PUCCH) (to network). Further, the relay WTRU 102a may send the indication in another feedback indication, e.g. CSI report, HARQ feedback, and/or in a data PDU, such as a physical SL shared channel (PSSCH) (to remote WTRU 102b) and/or a physical UL shared channel (PUSCH) (to network) WTRU uses different identifiers at adaptation layer in a case where (e.g., when) forwarding data from source remote WTRU 102b to destination remote WTRU 102c.

According to embodiments, for example associated with routing in WTRU-to-WTRU relaying, the relay WTRU 102a may use different pairs of identifiers at an adaptation layer in a case where (e.g., when) forwarding PDUs from source remote WTRU 102b to destination remote WTRU 102c. Typically, a pair of identifiers may comprise (e.g., consist of) source WTRU ID and destination WTRU ID. The relay WTRU 102a may provide a first pair of identifiers to the source remote WTRU 102b, for example, during end-to-end link/radio bearer establishment. The first pair of identifiers may comprise (e.g., consist of) a source WTRU ID corresponding to a relay WTRU 102a assigned source WTRU ID, and a destination WTRU ID corresponding to an ID of the relay WTRU 102a or an ID (e.g. assigned by relay WTRU 102a) which maps to the destination remote WTRU 102c.

The relay WTRU 102a may also provide a second pair of identifiers to the destination remote WTRU 102c. The second pair of identifiers may include of a source WTRU ID corresponding to an ID of the relay WTRU 102a or an ID (e.g. assigned by relay WTRU 102a) which maps to the source remote WTRU 102b. The second pair of identifiers may also include a destination WTRU ID corresponding to the relay WTRU 102a assigned destination WTRU ID.

The relay WTRU 102a may use an adaptation layer ID mapping rule to map between the first pair of identifiers to a second pair of identifiers and vice-versa. The adaptation layer ID mapping rule may also be used in a case where (e.g., when) forwarding PDUs from one source remote WTRU 102b to multiple destination remote WTRUs 102c and for forwarding PDUs from multiple source remote WTRUs 102b to one destination remote WTRU 102c, for example. In these cases, the associated source IDs and destination IDs may be changed at the adaptation layer based on the mapping rule. In some examples the source WTRU ID and destination WTRU ID may correspond to the associated L2 source WTRU ID and L2 destination WTRU ID. In other example, the source WTRU ID may correspond to the L2 source WTRU ID of the source remote WTRU 102b while the destination ID may be assigned by relay WTRU 102a. According to embodiments, both the source ID and destination ID are assigned by the relay WTRU 102a.

The first pair of identifiers may be inserted by the source remote WTRU 102b at the adaptation layer by appending an adaptation layer header (e.g. containing the identifiers) to the PDUs intended to be forwarded to the destination remote WTRU 102c via relay WTRU 102a. The PDUs appended the adaptation layer header are in such a case sent by the source remote WTRU 102b to the relay WTRU 102a. In a case where (e.g., upon) receiving the PDUs at the adaptation layer, the relay WTRU 102a may use the adaptation layer IDs mapping rule for changing/replacing the first pair of identifiers in the received PDUs with a second pair of identifiers. The relay WTRU 102a may insert the second pair of identifiers in the adaptation layer header of the PDUs intended to the destination remote WTRU 102c, for example. Subsequently, the relay WTRU 102a may send PDUs to the destination remote WTRU 102c.

In the case when the destination remote WTRU 102c performs transmission to the source remote WTRU 102b, a similar procedure using the second pair of identifiers assigned by the relay WTRU 102a may be applied by inserting the identifiers at the adaptation layer of the destination remote WTRU 102c.

### 2.1.1. Methods for Determining the Mapping Configuration

A WTRU 102 may be configured to perform mapping at an adaptation layer based on a mapping configuration. For example, the relay WTRU 102a may perform mapping from N RLC channels (for example, where N=1) to any number of egress RLC channels at the adaptation layer based on mapping configurations. The mapping of the PDUs from any number of ingress RLC channels, where any (e.g., each) RLC channel may be carrying any number of QoS flows, to egress RLC channel(s) may be performed such that the QoS achieved (e.g. throughput, latency) in a case where (e.g., upon) mapping is equivalent to the QoS prior to the mapping, for example. The ingress RLC channels and egress RLC channels may correspond to either Uu RLC channels or PC5 RLC channels, depending on whether the WTRU-to-NW relaying or WTRU-to-WTRU relaying is supported and/or whether the direction of relaying is UL or DL. For example, in the case of WTRU-to-NW relaying in the UL the ingress side corresponds to PC5 RLC channels and the egress side corresponds to Uu RLC channels. In DL relaying, the ingress side and egress side correspond to Uu RLC channels and PC5 RLC channels, respectively.

The relay WTRU 102a may be configured with the mapping configurations at the adaptation layer in various ways. For example, the relay WTRU 102a may be configured by a network (e.g. via RRC signaling for WTRU-to-NW and WTRU-to-WTRU relaying). Additionally, the relay WTRU 102a may be configured by a remote WTRU 102b and/or other relay WTRU 102as (e.g. via PC5-signaling for WTRU-to-WTRU relaying). Also, the relay WTRU 102a may be configured by higher layers.

The mapping configurations configured in the relay WTRU 102a may correspond to any number of components. For example, an ingress RLC channel (with ID x) may be allowed to be mapped to an egress RLC channel (with ID y). Additionally, an ingress RLC channel (with ID x) may be allowed to be mapped to one of M egress RLC channels (with IDs y1, . . . yM). Also, a group of K ingress RLC channels (with IDs x1, . . . ,xK, with a group ID G) may be allowed to be mapped to one of M egress RLC channels (with IDs y1, . . . yM). Further, any number of the K ingress RLC channels in a group (with IDs x1, . . .,xK, with group ID G) may be allowed to be mapped to one of M egress RLC channels (with IDs y1, . . . yM). Yet further, any number of egress RLC channel may be excluded (or blacklisted) from being used for transmission of any number of ingress RLC channels. Further still, a first egress RLC channel may be prioritized over a second egress RLC channel, for transmission of a PDU from any number of ingress RLC channels.

According to embodiments, the allowed mapping from ingress to egress RLC channels may correspond to mapping/multiplexing restrictions where any number of ingress RLC channel may be restricted to be mapped/multiplexed to any number of egress RLC channels in a given mapping configuration. According to embodiments, where 1:N mapping is supported at the adaptation layer for mapping from an ingress RLC channel to any number of egress RLC channels, the different mapping configurations configured at relay WTRU 102a may correspond to various components. For example, an ingress RLC channel (with ID x) may be allowed to be mapped to M egress RLC channels (with IDs y1, . . . yM). Additionally, a group of K ingress RLC channels (with IDs x1, . . . , xK, with a group ID G) may be allowed to be mapped to M egress RLC channels (with IDs y1, . . . yM). Also, any number of the K ingress RLC channels in a group (with IDs x1, . . . , xK, with group ID G) may be allowed to be mapped to M egress RLC channels (with IDs y1, . . . yM)

A relay WTRU 102a may be configured with any number of conditions for determining the mapping configuration, where such conditions are previously described herein. For example, a relay WTRU 102a may be configured with a (range of) CBR for which mapping from (any number of) ingress RLC channel to (any number of) egress RLC channel is allowed/not allowed, or for which an egress RLC channel can be selected for any number of ingress RLC channels. A relay WTRU 102a may be configured with a combination of conditions (e.g., channel measurements and condition related to the ingress RLC channel) to determine such mapping.

The allowed mapping configuration may also be restricted based on the type of the traffic carried in the ingress/egress RLC channels, for example. As an example, the ingress RLC channels carrying GBR or non-GBR (e.g., best effort) traffic may be allowed (e.g., only) to be mapped to other egress RLC channels configured to carry the respective traffic types.

Similar to the case of N:1 mapping, the different mapping configurations or the association between the ingress and egress RLC channels may be identified with a mapping configuration ID. Additionally, in a case where (e.g., when) performing 1:N mapping, the relay WTRU 102a may also be configured with a splitting criterion for splitting the traffic in the ingress buffer between the multiple egress buffers/RLC channels. The splitting criterion may correspond to any number of conditions which may be similar to the conditions previously described herein in which the WTRU may perform an action (e.g., changing mapping configuration at an adaptation layer and/or configuration at an egress RLC channel) for changing the treatment of PDUs for fulfilling remaining QoS, for example.

The relay WTRU 102a may use the mapping configurations at the adaptation layer either semi-statically or dynamically in a case where (e.g., when) performing N:1 or 1:N mapping. In the case of semi-static configuration at the adaptation layer, the relay WTRU 102a may use the mappings configured until a reconfiguration message is received (e.g., via RRC signaling from a network). In the case of dynamic (re)configuration, the relay WTRU 102a may be initially pre-configured with a set of different mapping configurations, as previously described herein. The relay WTRU 102a may in such a case dynamically change or select any number of mapping configurations from the set of (pre)configurations based on triggering conditions determined at the relay WTRU 102a and/or based on an indication message (e.g., activation/deactivation) received from the network or remote WTRU 102b, for example. According to embodiments, the relay WTRU 102a may autonomously determine the mappings at the adaptation layer based on the triggering conditions detected at the relay WTRU 102a and/or based on an indication message received from a remote WTRU/network. In an example, the relay WTRU 102a may indicate the mapping configuration ID(s), to a network and/or another relay/remote WTRU 102b, in a case where (e.g., when) changing/updating the mapping configuration in any of the following combinations: N:1 to 1:1 and vice-versa, N:1 to 1:N and vice-versa, 1:N to 1:1 and vice-versa. The descriptions on the triggering conditions and indication messages are previously described herein.

In addition to the mapping configurations, the relay WTRU 102a may also be configured with default mapping in a case where (e.g., when) mapping the any number of ingress RLC channels to the egress RLC channels. For example, in the case in a case where (e.g., when) the relay WTRU 102a is configured to map any number of ingress RLC channels to one of M allowable egress RLC channels, the relay WTRU 102a may map the ingress channel to a default egress RLC channel which may be configured within the M allowable egress RLC channels (e.g. an ingress RLC channel with ID x may be mapped to a default egress RLC channel with ID y). Alternatively or additionally, the default RLC channel may be configured commonly for all ingress RLC channels.

A relay WTRU 102a may map an ingress RLC channel to a default RLC channel in response to various determinations. For example, the WTRU may use a default mapping configuration, for example, in response to the relay WTRU 102a determining that the conditions described herein result in none of the configured egress RLC channels being allowable for the ingress RLC channel. Additionally, the WTRU may use a default mapping configuration in response to the relay WTRU 102a determining that the ingress RLC channel has less than N ingress RLC channels with similar QoS. Also, the WTRU may use a default mapping configuration in response to the relay WTRU 102a determining that a condition specific to the use of a default RLC channel is satisfied. For example, the relay WTRU 102a may determine that the remaining QoS for an ingress RLC channel exceeds a threshold and/or that the remaining QoS for an ingress RLC channel exceeds the end-to-end QoS.

The ingress and egress RLC channels may be associated with any number of ingress and egress buffers, respectively. The ingress buffers may be used for storing the received PDUs prior to mapping to the egress buffers at the adaptation layer while the egress buffers are used for storing the PDUs in a case where (e.g., upon) mapping prior to sending the PDUs via the egress RLC channel, for example. In some examples, the ingress and egress buffers may correspond to the LCH buffers, which may be associated with the RLC buffers, on the ingress and egress sides respectively.

Additionally, any (e.g., each) of the M egress RLC channels allowable for mapping from ingress RLC channels may also be associated with a priority value or an index value, for example. The relay WTRU 102a may map the PDUs from a radio bearer to an egress RLC channel with the highest priority, for example, until a mapping criterion is satisfied before mapping the PDUs to an egress RLC channel with the next highest priority, for example. The mapping criterion may correspond to any of: a PDU count, a buffer in the egress RLC channel exceeds a threshold, and/or expiry of a timer. The mapping criterion, which the relay WTRU 102a may use in a case where (e.g., when) mapping/multiplexing, may be configured to achieve a particular behavior such as proportional fairness or round robin, for example. In the case when the configured criterion is to achieve fairness, the relay WTRU 102a may apply a configured fairness metric such that the number and/or type of QoS flows (e.g., GBR, non-GBR) carried by the active ingress RLC channels (e.g., non-empty) are taken into account in a case where (e.g., when) mapping at an adaptation layer, for example.

According to embodiments, the WTRU 102 may perform the mapping at an adaptation layer based on a mapping configuration wherein the PDUs with similar remaining/residual QoS may be mapped to an egress buffer associated with an egress RLC channel. For example, where the network may split the E2E QoS into per-hop/H2H QoS, it may be possible for splitting the E2E QoS such that the remaining QoS in the second hop is either the same or relatively similar between multiple QoS flows. For example, different E2E QoSs may be split such that the per-hop QoS on the first hop (e.g., over PC5 link(s)) may be different and the per-hop QoS on the second hop (e.g., over Uu link or PC5 link) may be similar to all flows which are multiplexed on to the same RLC channel. The QoS splitting and mapping may be applicable for WTRU-to-NW relaying and WTRU-to-WTRU relaying where the mapping may be performed to a Uu RLC channel and a PC5 RLC channel, respectively.

The relay WTRU 102a may receive a mapping configuration (e.g., from network) to be applied at an adaptation layer based on the characteristics of traffic carried by the ingress RLC channels (e.g., number and traffic load carried by ingress channels). In particular, the relay WTRU 102a, which may be configured to perform N:1 mapping at the adaptation layer, may map the PDUs in ingress RLC channels to an egress RLC channel which may be configured to achieve/enforce common remaining QoS to all mapped PDUs.

For supporting N:1 mapping, an egress RLC channel at relay WTRU 102a may be configured such that it may sufficiently support/handle the increased load as a result of mapping/multiplexing. According to embodiments, the configuration parameters typically applied at multiple egress RLC channels in a case where (e.g., when) supporting 1:1 mapping may be aggregated for supporting N:1 multiplexing to the one egress RLC channel. The load on the one (e.g., aggregated) egress RLC channel may be proportional to the number of mapped/multiplexed ingress RLC channels, for example. As an example, for an egress RLC channel which may carry PDUs from N ingress RLC channels in a case where (e.g., upon) mapping, the PBR configuration at MAC sublayer of the egress RLC channel may be configured as the sum of the PBR values in the N RLC channels, e.g., Σᵢ₌₁^{N}PBRᵢ. Similarly, for ensuring the latency achieved over the one egress RLC channel may satisfy the per-hop latency (e.g. remaining QoS) for all N mapped QoS flows, the priority and/or BSD parameters at a MAC sublayer may be configured as the minimum of the priority and/or BSD values in the N ingress RLC channels, e.g. min(priorityᵢ) and/or min(BSDᵢ), i=1, . . . , N, for example.

According to embodiments, the WTRU may perform N:1 mapping at an adaptation layer using a semi-static mapping configuration. For example, the mapping configuration at an adaptation layer at a relay WTRU 102a may be semi-statically configured and the relay WTRU 102a may map the PDUs from any number of ingress buffers to the egress buffer based on the configuration. For example, the mapping configuration may include allowed mapping from ingress RLC channels with IDs 1, . . . , K to an egress RLC channel with ID X. The mapping configuration ensures that the relay WTRU 102a may map (e.g., only) the PDUs from ingress RLC channels/buffers having remaining QoS in the next-hop that has been semi-statically adjusted to be common during E2E QoS splitting and/or configuration, for example.

According to embodiments, the WTRU may perform N:1 mapping at an adaptation layer using a dynamic mapping configuration. For example, the relay WTRU 102a may dynamically change the mapping configuration and/or select one of a number of configured allowable egress RLC channels for a given ingress RLC channel. Such a decision may be based on determination of the remaining QoS for an ingress RLC channel. For example, an egress RLC channel may be selected for mapping the PDUs from the ingress RLC channels by matching the remaining QoS with associated criteria associated/configured with the next hop link (e.g., the achievable/enforceable QoS in the next-hop link (Uu link or PC5 link)). The relay may be (pre)configured with any number of egress RLC channels, which may be configured (e.g., by network) with parameters for achieving/enforcing a particular per-hop QoS (e.g., latency) and/or aggregated load value in the next-hop. For example, the relay WTRU 102a may be configured with an egress RLC channel to be used for a given remaining QoS. The relay WTRU 102a may also be configured with a mapping configuration indicating the egress RLC channel ID and the any number of parameter values indicating an achievable/enforceable range of QoS and/or allowed load. For example, the achievable QoS may correspond to supporting a latency range between l1 ms to l2 ms (min, max), throughput/bit-rate range of r1 Mbps to r2 Mbps (min, max). Also, the allowed load may correspond to a max number of ingress RLC channels. The ingress RLC channels may correspond to non-empty active ingress buffers, which have at least one PDU, for example. The allowed load may also correspond to a max number of PDUs that may be mapped during a mapping instance/window/cycle. In this case the mapping window may correspond to a certain (configured) time duration (e.g., with start/end time) during which a batch of PDUs may be mapped to an egress buffer.

The relay WTRU 102a may determine the remaining QoS of the received PDUs in the ingress RLC channels, based on any number of attributes described herein, and may map the PDUs to an egress RLC channel based on a QoS similarity criterion. For example, the QoS similarity criterion may indicate mapping allowed from the ingress to egress RLC channel if the difference between the remaining QoS for PDUs in an ingress RLC channel and the achievable/enforceable QoS (e.g., min or max value in the range) configured in the egress RLC channel is below a configured threshold. In a case where (e.g., when) applied to the any number of ingress RLC channels, the QoS similarity criterion may enable mapping on the basis of common remaining QoS to an egress RLC channel, whose configuration (e.g., achievable QoS and load) matches with the remaining QoS. For example, in a WTRU-to-NW relay, the PDUs received via any number of PC5 ingress RLC channels that have the same remaining latency to be achieved/enforced over the Uu link may be mapped to a Uu RLC channel that is configured with parameters (e.g. LCP rules/restrictions, priority, BSD) for satisfying the remaining latency and/or is within the maximum load value (e.g. number of ingress RLC channels/PDUs is less than or equal to the max values) allowed to be mapped.

According to embodiments, the relay WTRU 102a may select a (pre)configured egress RLC channel in a mapping instance/window for mapping the PDUs/traffic from any number of ingress RLC channels/buffers. The selection of a (pre)configured egress RLC channel may be made based on matching of the QoS characteristics between the remaining QoS of the traffic in an ingress RLC channel and/or the QoS achievable by the egress RLC channel, for example. For example, the relay WTRU 102a may dynamically select a first egress RLC channel configuration for mapping the traffic/PDUs from a first ingress buffer in a mapping time duration/window. The relay WTRU 102a may in select a second egress RLC channel configuration for mapping the traffic/PDUs from a second ingress buffer in the following mapping time duration/window.

According to embodiments, the relay WTRU 102a may drop any number of PDUs in a PDU batch in the ingress buffer in a case where (e.g., when) the remaining QoS for the batch does not (e.g., is unable) to meet the achievable QoS in the next hop. For example, the relay WTRU 102a may decide to drop a batch of PDUs (e.g., any number of PDUs) in a case where (e.g., when) the remaining delay over the Uu link is less than the achievable delay on the Uu link. The relay WTRU 102a may drop the PDU batch at the ingress buffer prior to mapping at the adaptation layer to an egress buffer, for example. For example, a relay WTRU 102a may drop any number of PDUs in a PDU batch in the ingress buffer if a corresponding egress RLC channel is not configured for the ingress buffer which corresponds to the remaining QoS. Alternatively or additionally, the relay WTRU 102a may drop the PDU batch in a case where (e.g., upon) mapping to the egress buffer, prior to sending to lower layers (e.g., MAC, PHY), for example. In a case where (e.g., when) dropping the any number of PDUs, the relay WTRU 102a may send an indication to the remote WTRU 102b and/or network, indicating the information on dropping (e.g., number of PDUs dropped, sequence number (SN) IDs), for example.

### 2.1.2. Methods for Determining the RLC Channel Configuration

According to embodiments, the relay WTRU 102a may select an egress RLC channel configuration to be applied in a case where (e.g., when) performing mapping/multiplexing at an adaptation layer. For example, the relay WTRU 102a may select an egress RLC channel configuration to be applied in a case where (e.g., upon) mapping/multiplexing at the adaptation layer based on the remaining QoS of the received PDUs in the ingress RLC channels. The selection of an egress RLC channel configuration may be made by the relay WTRU 102a using various techniques.

One technique that may be used by the relay WTRU 102a may be based on reception (e.g., from a network) of a configuration on an egress RLC channel. For example, a WTRU (e.g., a relay WTRU 102a) may request an RLC channel (re)configuration by transmitting an indication to the network in response to satisfaction of any of the conditions described herein.

Another technique that may be used by the relay WTRU 102a may be based on (autonomous) (re)selection from a set of (pre)configured egress RLC channel configurations based on selection rules and conditions. For example, a WTRU (e.g., a relay WTRU 102a) may be configured with any number of conditions (based on the conditions discussed herein) as to which of the (pre)configured RLC channel configurations is to be applied. A WTRU may further indicate to the network if it changes the configuration.

Another technique that may be used by the relay WTRU 102a may be based on dynamic activation/deactivation of any number of (pre)configured RLC channel configurations based on an indication received from a network and/or another relay/remote WTRU 102b. For example, a relay WTRU 102a may receive an activation and/or deactivation of any number of configured RLC configurations from the network and/or another relay/remote WTRU 102b, and may apply the RLC configuration of the activated channel.

Another technique that may be used by the relay WTRU 102a may be based on derivation of the parameters to be applied at the egress RLC channel.

A relay WTRU 102a may further indicate the selected RLC configuration or change in the RLC configuration to the network and/or other WTRU (e.g., remote WTRU 102b) using mechanisms described herein.

According to embodiments, the relay WTRU 102a may receive configurations associated with any number of egress RLC channels from the network and/or other remote/relay WTRU 102as. The relay WTRU 102a may receive the configurations (e.g., from the network) based on the indication provided by the relay WTRU 102a containing information related to the remaining QoS (e.g., priority, latency, CBR measurements on SL) and/or the loading attributes associated with the ingress RLC channels. The configuration of the egress RLC channels may be received by the relay WTRU 102a in the same or different signaling/messages used for receiving the adaptation layer mapping configurations, for example.

According to embodiments, the relay WTRU 102a may be (pre)configured (e.g., by the network) with any number of egress RLC channel configurations (e.g., over Uu for WTRU-to-NW relaying or over PC5 for WTRU-to-WTRU relaying). The different (pre)configurations may be configured with different parameters associated with the sublayers (e.g., RLC: AM/UM, MAC: LCP rules/restrictions, PBR, BSD, priority, PHY) within the RLC channel for achieving/enforcing certain QoS (e.g., delay, throughput, reliability) over the next-hop link. The different (pre)configurations may also be associated with different identifiers/IDs. The relay WTRU 102a may also be configured with selection rules and conditions for assisting with the selection of an egress RLC channel (pre)configuration. The relay WTRU 102a may autonomously select a (pre)configuration based on the selection rules and conditions.

For example, the selection rules may indicate selecting a (pre)configuration X in a case where (e.g., when) any number of selection conditions are met. The selection conditions may be related to the triggering conditions, previously described herein, for example. In an example, the selection conditions associated with the selection rules may be related to the remaining QoS of the PDUs in ingress RLC channels and/or the loading attributes (e.g., number of (active) ingress RLC channels to be mapped). As an example, the relay WTRU 102a may select a (pre)configuration X for the egress RLC channel if the remaining QoS of the PDUs in any number of ingress RLC channels is within a certain range (e.g., within a min value and max value for delay, bitrate and/or priority). Similarly, the relay WTRU 102a may select a (pre)configuration if the load attributes are within a certain range (e.g., number of active ingress RLC channels are less than or equal to a maximum value), for example.

According to embodiments, the any number of (pre)configurations associated with the mapping configuration may be dynamically activated/deactivated by the relay WTRU 102a based on an indication received from the network (e.g., in RRC signaling, MAC CE or DCI) and/or other relay/remote WTRU 102b (e.g., in PC5-RRC signaling, adaptation layer control, SL MAC CE, or SCI). The indication may contain the identifier/ID of the (pre)configuration to be activated/deactivated. The relay WTRU 102a may receive the activation/deactivation indication based on other indications sent by relay WTRU 102a, for example, containing information on the remaining QoS and/or loading attributes associated with the ingress RLC channels, for example.

According to embodiments, the relay WTRU 102a may derive/determine the any number of parameters associated with the egress RLC channel. The relay WTRU 102a may be configured with a mapping rule configuration for determining the parameters associated with any number of sublayers in the egress RLC channel. The mapping rule configuration may be used based on the remaining QoS and/or loading attributes of the ingress RLC channels determined by the relay WTRU 102a, for example. According to embodiments, the relay WTRU 102a may determine any number of configuration parameters to be applied at the egress RLC channel based on the mapping rule configuration which may map from the remaining QoS (e.g., min of remaining latency among all active ingress RLC channels) to the RLC channel configuration (e.g., LCH priority). The relay WTRU 102a may also send an indication (e.g., to network) in a case where (e.g., upon) determining and/or changing the configuration applied at the egress RLC channel.

The selection of the egress RLC channel configuration may be made by the relay WTRU 102a before or after performing the mapping/multiplexing from ingress buffers to an egress buffer at the adaptation layer. For example, in the case of selection before mapping, the relay WTRU 102a may initially buffer the received PDUs over the ingress RLC channels in the associated ingress buffers. The relay WTRU 102a may (e.g., subsequently) select an egress RLC channel configuration and/or the associated buffer in a case where (e.g., upon) determining the remaining QoS and/or the mapping rule configuration (e.g., RCF values). The relay WTRU 102a may perform the selection such that the achievable QoS on the selected egress RLC channel may support the remaining QoS of all mapped ingress RLC channels, for example. In the case of selection after mapping, the relay WTRU 102a may initially map from the any number of ingress buffers to an egress buffer, based on an existing/default adaptation mapping configuration. The relay WTRU 102a may (e.g., subsequently) select an egress RLC channel configuration and/or associate the selected configuration with the egress buffer containing the mapped PDUs. The selection may be performed considering any number of factors including the remaining QoS of the mapped PDUs and distribution of the mapped PDUs with different remaining QoS (e.g., number of PDUs within any (e.g., each) remaining QoS amount, start/end marker indicating different remaining QoS), for example.

### 2.1.3. Methods for Determining the Ordering of PDUs

The relay WTRU 102a may determine and/or apply relative QoS compensation for ingress RLC channels during mapping. For example, the relay WTRU 102a may determine relative compensation factor values (RCF) for compensating the different remaining/residual QoS associated with the PDUs received in any number of ingress RLC channels and/or apply the RCF values at an adaptation layer in a case where (e.g., when) mapping from the ingress to egress RLC channels. The PDUs received over any number of PC5 ingress RLC channels from the same or different remote WTRUs may experience different QoS (e.g., delay). This difference in delay may be, for example, due to transmission over different sidelink resource pools which may experience different congestion and channel conditions. Consequently, the remaining QoS (e.g., delay, throughput) to be achieved/enforced in the next-hop (Uu link for WTRU-to-NW relaying or PC5 link for WTRU-to-WTRU relaying) may vary at any number of different levels/granularities. For example, the remaining QoS may vary between one ingress RLC channel and another. Also, the remaining QoS may vary between one transmission window/instance, comprising (e.g., consisting of) any number of PDUs in a PDU batch, and another within the same ingress RLC channel. In this regard, in a case where (e.g., when) N:1 mapping/multiplexing is performed at the adaptation layer of the relay WTRU 102a to an egress RLC channel based on the order of PDU arrival, it may be possible that the different remaining QoS for the mapped PDUs from any number of ingress RLC channels may not be satisfied.

According to embodiments, the relay WTRU 102a may perform mapping at the adaptation layer based on the awareness of the remaining QoS associated with the ingress RLC channels and/or the batch of PDUs within a transmission/reception window such that different compensation/weighting values may be applied in a case where (e.g., when) mapping to the egress RLC channel. For example, for PDUs in an ingress buffer that may be delayed over the first hop (e.g., PC5 link), for example, exceeding the configured first-hop delay budget, the relay WTRU 102a may compensate by assigning higher priority or weighting value to the delayed PDUs/ingress buffer. For PDUs in an ingress buffer which may have arrived early (e.g., due to favorable SL channel/load conditions), the relay WTRU 102a may compensate by assigning lower priority or weighting values to the early PDUs/ingress buffer, for example. In either case, the increasing/decreasing of the priority or weighting values may be performed relative or proportional to the different active ingress RLC channels (e.g., ingress RLC channels with at least one PDU) and may represent the relative compensation factor (RCF) values to be applied in a case where (e.g., when) mapping/multiplexing. As an example, in a case where (e.g., when) applying the RCF values to the PDUs in the different ingress buffers, the number of PDUs that may be mapped to the egress buffer in a given mapping window/cycle may be proportional to the priority/weight values represented by the RCF values.

As an example, the process executed in a case where (e.g., when) performing the mapping/multiplexing at the adaptation layer of relay WTRU 102a contains several steps. For example, the relay WTRU 102a may determine the remaining QoS for the any number of active ingress RLC channels (e.g., ingress RLC channels containing at least one PDU). Additionally, the relay WTRU 102a may determine the RCF values (e.g., priority/weight values) to be applied to any (e.g., each) of the active ingress RLC channels as a function of the determined remaining QoS. Also, the relay WTRU 102a may apply the determined RCF values in a case where (e.g., when) mapping/multiplexing from ingress buffers to an egress buffer.

The relay WTRU 102a may determine the remaining QoS of the active ingress RLC channel based on any number of impacting attributes previously described herein. The relay WTRU 102a may determine the RCF values to be applied to ingress RLC channels based on any number of configuration types. For example, the relay WTRU 102a may determine the RCF values for a semi-static configuration. The relay WTRU 102a may receive an adaptation layer mapping rule configuration for mapping from the remaining QoS and/or attributes impacting the remaining QoS (e.g., CBR, priority indication from remote WTRU) to the RCF values (e.g., priority/weight values). The mapping configuration may be received from network (e.g., via RRC signalling) or from another remote WTRU/relay WTRU 102a (e.g., via PC5-RRC signalling). Alternatively, the relay WTRU 102a may be initially configured with a default mapping configuration for mapping from ingress to egress RLC channels. Such default mapping configuration may also be associated with any number of parameters related to the determined remaining QoS (e.g., priority of the ingress RLC channels, CBR measurements), which the relay WTRU 102a may monitor/track prior to changing and/or sending a request for changing the default mapping configuration. For receiving a mapping configuration (e.g., default or updated), the relay WTRU 102a may send an indication (to a network or another relay/remote WTRU) indicating the information on the remaining QoS associated with the PDUs in the ingress RLC channels/buffer, for example. The relay WTRU 102a may send the indication that may trigger the reception of a mapping configuration based on any number of triggering conditions previously described herein. According to embodiments, the configuration applied at the egress RLC channel to which the ingress RLC channels are mapped, may also be changed/modified (e.g., by network and/or relay/remote WTRU) in a case where (e.g., when) changing or receiving a new/updated adaptation layer mapping rule configuration.

Alternatively or additionally, the relay WTRU 102a may determine the RCF values for a dynamic configuration. For example, the relay WTRU 102a may be preconfigured with any number of adaptation layer mapping rule configurations for mapping from the any number of factors associated with remaining QoS to the RCF values (e.g., priority/weight). The different mapping rule configurations may be identified with different IDs. The different mapping configurations may be dynamically activated/deactivated autonomously based on triggering conditions previously described herein. Alternatively or additionally, the mapping configuration may be activated/deactivated in a case where (e.g., when) receiving an indication from the network (e.g., via RRC signalling, MAC CE, or DCI) or from another relay WTRU 102a/remote WTRU 102b in SL (e.g., via PC5-RRC signalling, adaptation layer control PDU, SL MAC CE or SCI). The received indication may contain the ID of the associated mapping configuration for activation/deactivation. For receiving the dynamic activation/deactivation indication, the relay WTRU 102a may send an indication (to a network or another relay/remote WTRU) indicating the remaining QoS associated with PDUs in ingress RLC channels/buffers, for example. The relay WTRU 102a may send the indication that may trigger the reception of the activation/deactivation indicator based on any number of triggering conditions previously described herein.

According to embodiments, for example involving determination of the RCF values for a dynamic configuration, changing any number of RCF values may translate to dynamic (re)configuration of the mapping configuration at an adaptation layer. RCF values may be changed by the relay WTRU 102a (e.g., based on triggering conditions or indications received from a network/remote WTRU). For example, decreasing an RCF value may translate to lowering the priority assigned and/or throttling the rate of PDU transmission from an ingress RLC channel/buffer. Increasing an RCF value may translate to increasing the priority and/or increasing the rate of PDU transmission from an ingress RLC channel.

According to embodiments, for example involving determination of the RCF values for a dynamic configuration, the configuration applied at the egress RLC channel to which the ingress RLC channels are mapped may be dynamically changed/modified in a case where (e.g., when) activating/deactivating a mapping configuration dynamically.

The relay WTRU 102a may also perform derivation of a mapping configuration. For example, the relay WTRU 102a may derive/determine the RCF values (e.g., priority/weight) as a function of any number of attributes impacting the remaining QoS. As an example, for a set of N active ingress RLC channels, which may have different remaining QoS (rQoS), the relay WTRU 102a may use the following function/formulation for determining the RCF values:

$${min}_{{RCF}_{i}} max ( {rQoS}_{i} ( {RCF}_{i} ) ) , subject to {\sum }_{i = 1}^{N} {RCF}_{i} = 1$$

According to embodiments, the relay WTRU 102a may derive/determine the RCF values as a function of the any number of configurations associated with the egress RLC channels, which may be configured to achieve/enforce a certain (e.g., expected) QoS and/or load value in a case where (e.g., upon) mapping from ingress RLC channels. The derivation of the RCF values based on the (e.g., expected) QoS and/or load may be performed by the relay WTRU 102a, for example, with or without the consideration of the remaining QoS associated with the PDUs in the ingress RLC channels, for example. As an example, considering the achievable QoS (aQoS) of an egress RLC channel j (e.g., maximum delay value in a given delay range achievable with the configuration), an additional constraint that may be considered in the function/ formulation above for determining the RCF value may be the following:

min(rQoSᵢ(RCFᵢ))≥max (aQoSⱼ).

In one example, the relay WTRU 102a may (re)select an egress RLC channel, for example, from any number of preconfigured egress RLC channels with different configurations, in a case where (e.g., when) determining/deriving the RCF values to be applied at the adaptation layer. The different configurations may be associated with different achievable/enforceable QoS in the next-hop link (e.g., Uu or PC5). Such QoS in the next-hop link may be achieved based on the configuration applied in the different sublayers of the egress RLC channel, including LCP rules/restrictions, MAC configuration (e.g., PBR, BSD, priority) and PHY configuration, for example.

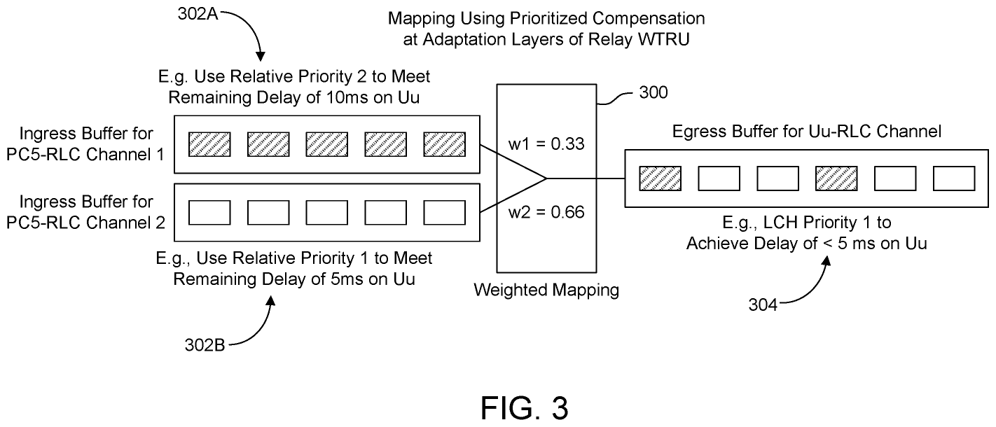

Referring to FIG. 3, a relay WTRU 102a determines and applies relative priority compensation (e.g., weighted mapping 300) for ordering the PDUs received from multiple ingress PC5 RLC channels in a case where (e.g., when) mapping on to an egress Uu RLC channel. In an example, the relay WTRU 102a may use a first compensation value (e.g., weight w1=0.33) for PDUs buffered in ingress buffer (also referred as IRC buffer) 302A associated with PC5-RLC channel 1 and a second compensation value (e.g., weight w2=0.66) for PDUs buffered in ingress buffer 302B associated with PC5-RLC channel 2. The relay WTRU 102a may apply the first and second compensation values in a case where (e.g., when) performing mapping 300 at the adaptation layer to an egress buffer 304 associated with a Uu-RLC channel.

According to embodiments, the relay WTRU 102a may determine the forwarding configuration, including the priority values and/or weight values (e.g., RCF values) associated with the IRCs, based on the buffer status of the IRCs. The buffer status of the IRCs and the associated actions of the relay WTRU 102a in a case where (e.g., when) determining the forwarding configuration may correspond to any number of the following:
Full buffer:
   For example, the relay WTRU 102a may determine the IRC buffer 302A, 302B to be full in a case where (e.g., when) the number of PDUs in the buffer is higher than a PDU count threshold. According to embodiments, the IRC buffer 302A, 302B may be determined to be full in a case where (e.g., when) the total amount of payload of the PDUs in the buffer is higher than a payload threshold. The PDU count threshold and/or payload threshold may be configured in the WTRU, for example, in a case where (e.g., when) a default forwarding configuration is configured, along with default priority/weight values for the IRCs, for example.
   The relay WTRU 102a may determine that an IRC is active in a case where (e.g., when) determining that the IRC buffer 302A, 302B is full, for example. For example, in the case when all IRC buffers 302A, 30B may be determined to be full and/or active, the relay WTRU 102a may determine the priority/weight values of the full IRCs based on the respective default priority/weight values. The relay WTRU 102a may in such a case use the determined priority/weight values for performing selection of a preconfigured forwarding configuration and/or performing derivation of a mapping configuration (e.g., derivation of updated priority/weight values by using the initial priority/weight value as inputs to the derivation operation described in another section of this disclosure), in a case where (e.g., when) determining the forwarding configuration to apply at adaptation layer, for example.
Empty buffer:
   For example, the relay WTRU 102a may determine the IRC buffer 302A, 302B to be empty in a case where (e.g., when) the number of PDUs and/or the total payload size in the buffer is zero or less than a PDU count and/or payload threshold. The relay WTRU 102a may determine that an IRC is inactive in a case where (e.g., when) determining that the IRC buffer 302A, 302B is empty, for example. The relay WTRU 102a may assign a priority/weight value of zero or may not include an inactive IRC in a case where (e.g., when) determining the forwarding configuration and/or the priority/weight/RCF values, for example.
Partial buffer:
   For example, the relay WTRU 102a may determine the IRC buffer 302A, 302B as partially full in a case where (e.g., when) the number of PDUs in the buffer is less than an upper bound PDU count threshold and/or higher than a lower bound PDU count threshold. According to embodiments, the IRC buffer 302A, 302B may be determined to be partially full in a case where (e.g., when) the total amount of payload in the buffer is less than an upper bound payload threshold and/or higher than a lower bound payload threshold.
   In a case where (e.g., when) determining that at least one of the IRC buffers 302A, 302B is partially full, the relay WTRU 102a may adjust the priority/weight values associated with the partial IRC buffers 302A, 302B to be proportional to the priority/weight values applied in a case where (e.g., when) assuming a full buffer and to the number of PDUs and/or amount of payload with respect to the full buffer threshold values, for example. For example, for an IRC that may be assigned to or associated with a priority value of p1 in a case where (e.g., when) determined to be full, its adjusted priority value y, in a case where (e.g., when) under partial buffer condition may be determined as y=p1xp2, where p2 is the ratio of number of PDUs in the partial buffer over the number of PDUs in a case where (e.g., when) full (e.g. upper bound PDU count threshold) or the ratio of total payload in the partial buffer over the total payload in a case where (e.g., when) full (e.g. upper bound payload threshold).
   In a case where (e.g., upon) determining the adjusted priority/weight values for the associated any number of partial IRCs, the relay WTRU 102a may in such a case use the determined adjusted priority/weight values for performing selection of a preconfigured forwarding configuration and/or performing derivation of a mapping configuration (e.g. derivation of updated priority/weight values by using the adjusted priority/weight value as inputs to the derivation operation described in another section of this disclosure), in a case where (e.g., when) determining the forwarding configuration to apply at the adaptation layer, for example.

### 2.1.4. Methods for Informing Remote WTRU for Ensuring Uniformity in QoS

The relay WTRU 102a may send any number of indications to remote WTRUs 102b for ensuring similar/uniform remaining QoS is achievable at the relay WTRU 102a. For example, the relay WTRU 102a may send an indication to any number of remote WTRUs 102b for controlling the data transmission flow over the associated ingress PC5 RLC channels such that the E2E QoS of the QoS flows may be met in a case where (e.g., when) performing the mapping/multiplexing at the adaptation layer of relay WTRU 102a.

According to embodiments, the relay WTRU 102a may send the indication to the remote WTRUs to ensure that the timing and/or the order of PDU arrival at the relay WTRU 102a over the different ingress RLC channels can be controlled and/or results in having similar/uniform remaining QoS to be achieved/enforced in the next-hop at the egress RLC channel in a case where (e.g., upon) mapping. In a case where (e.g., upon) achieving a similar/uniform remaining QoS, the relay WTRU 102a may in such a case apply the any number of mapping configuration at the adaptation layer and egress RLC channel configuration for ensuring the QoS in the next-hop link (e.g., Uu or PC5).

According to embodiments, in a case where (e.g., when) using a (fixed) mapping configuration (e.g., RCF values) at the adaptation layer and/or egress RLC channel configuration, the relay WTRU 102a may determine the achievable/enforceable QoS (e.g., delay over the 2^{nd} hop) with the configurations (e.g., using a function described elsewhere or a mapping function received from a network). The relay WTRU 102a may also determine the (e.g., necessary) range for QoS in the first hop for the ingress RLC channels such that the E2E QoS for the QoS flows may be satisfied in a case where (e.g., when) using the (e.g., fixed) mapping configuration at an adaptation layer and egress RLC channel, for example. The relay WTRU 102a may in such a case identify any number of ingress RLC channels for achieving certain QoS that is within the determined QoS range (e.g., delay range over the 1^{st} hop). Based on the identification, the relay WTRU 102a may send the indication to remote WTRUs 102b associated with the ingress RLC channels for increasing/decreasing the rate of transmission of the PDUs such that the QoS achievable in the first hop falls within the determined QoS range, for example.

The relay WTRU 102a may send the indication to the remote WTRUs for ensuring uniform remaining QoS based on any number of triggering conditions. For example, the relay WTRU 102a may send the indication in response to a triggering condition relating to status of an ingress buffer. For example, the relay WTRU 102a may monitor the number of PDUs in the ingress buffers 302A, 302B associated with the ingress (PC5) RLC channels. An indication may be triggered for increasing/decreasing the rate of transmission over the ingress RLC channel in a case where (e.g., when) the number of PDUs in the ingress buffer increases/decreases with respect to a configured threshold, for example.

As another example, the relay WTRU 102a may send the indication in response to a triggering condition relating to a change in the adaptation layer mapping configuration and/or egress RLC channel configuration. For example, relay WTRU 102a may send an indication to remote WTRUs in a case where (e.g., upon) re-identifying the ingress RLC channels that may apply the updated configurations at an adaptation layer and/or egress RLC channel.

As another example, the relay WTRU 102a may send the indication in response to a triggering condition relating to a change in the SL conditions. For example, the relay WTRU 102a may send an indication to remote WTRUs 102b in a case where (e.g., when) determining the QoS achievable over the first-hop PC5 link falls outside/within a range that may be applicable to the existing mapping configuration and/or egress RLC channel configuration. As an example, an indication may be sent in a case where (e.g., when) the CBR/CR and/or SL RSRP/CSI measured over a resource pool associated with an ingress RLC channel is above/below a configured threshold.

As another example, the relay WTRU 102a may send the indication in response to a triggering condition relating to a change in loading at the relay WTRU 102a. For example, the relay WTRU 102a may send an indication to remote WTRUs in a case where (e.g., when) the loading status at the relay WTRU 102a changes as a result of arrival of PDUs from other remote WTRUs 102b, or higher layers or change in traffic prioritization, which may for example, impact the configuration applied and/or change the QoS in a case where (e.g., when) mapping/multiplexing.

As another example, the relay WTRU 102a may send the indication in response to a triggering condition relating to a change in achievable QoS in a next hop. For example, the relay WTRU 102a may send an indication to remote WTRUs 102b in a case where (e.g., when) (e.g., another) any number of indications are received from a network, other remote/relay WTRU 102as or higher layers, which may indicate the change in QoS achievable over the next hop(s). The received indications may include either explicit signalling indicating change in QoS or implicit indications (e.g., change in RSRP measurements on Uu link for WTRU-to-NW relaying or increase in congestion/CBR in next hop PC5 link for WTRU-to-WTRU relaying).

### 2.1.5. Methods for Triggering Resource Request/Reselection when Supporting Mapping/Multiplexing at Adaptation Layer

The relay WTRU 102a may also compensate for delay due to mapping/multiplexing at an adaptation layer by triggering for resource request/(re)selection preemptively. For example, a relay WTRU 102a may trigger a resource (re)selection or a resource request (e.g., scheduling request (SR)/buffer status reporting (BSR)) based on any of the conditions described herein. For example, the relay WTRU 102a may compensate for increased delay due to relaying related tasks by triggering preemptively the request for resources or autonomous resource (re)selection for subsequent transmission in the next-hop link (e.g., Uu link or PC5 link). The preemptive request for resources or resource (re)selection may be intended for reducing any latency associated with scheduling.

The relay WTRU 102a may compensate for the increased delay due to various causes. For example, increased delay may occur in a case where (e.g., when) transmissions over the first-hop PC5 link over the ingress RLC channels exceed the QoS budget (e.g., PDB on first hop). Additionally, increased delay may occur in a case where (e.g., when) configuration at the relay WTRU 102a is changed/updated, including any change in the adaptation layer mapping configuration (e.g., RCF values) and/or egress RLC channel configurations. Also, increased delay may occur in a case where (e.g., when) loading conditions at any number of ingress/egress RLC channels relay WTRU 102a change (e.g., due to arrival of PDUs from remote WTRUs 102b or higher layer with higher priority) that may result in increased delay due to buffering.

In the above scenarios, the relay WTRU 102a may send the request for resources preemptively in SR/BSR (e.g., for transmission over Uu link) or initiate resources (re)selection (e.g., when resources are selected autonomously in Mode 2 for transmission in next-hop PC5 link), for example. The relay WTRU 102a may send the request for resources (SR/BSR) or trigger resource (re)selection, prior to the arrival of the PDUs in the egress RLC channels and/or any egress logical channels at the relay WTRU 102a, based on any number of criteria. For example, the WTRU may take any number of these actions in response to buffering delay at ingress RLC channels: for example, the relay WTRU 102a may trigger a resource request in a case where (e.g., when) a PDU batch, comprising (e.g., consisting of) any number of PDUs, are buffered in an ingress RLC channel/buffer beyond a configured threshold duration. Additionally, the WTRU may take any number of the aforementioned actions in response to buffering delay at egress RLC channels/LCHs. For example, the relay WTRU 102a may trigger a resource request for an egress RLC channel/LCH with lower priority in a case where (e.g., when) the resource uses (e.g., needs) for other egress RLC channels/LCHs with higher priority have been met (e.g., using available resources due to improved channel/load conditions) or can be met (e.g., a BSR has been triggered previously).

Also, the WTRU (e.g., relay WTRU 102a) may take any number of the aforementioned actions in response to mapping/multiplexing delay at an adaptation layer: for example, the relay WTRU 102a may trigger a resource request in a case where (e.g., when) the configuration associated with a PDU batch of any number of PDUs (e.g. RCF) and/or any number of ingress RLC channels is changed at the adaptation layer, which may for example, result in increase in higher scheduling and transmission latency for the impacted PDUs/RLC channels. The relay WTRU 102a may trigger a resource request in a case where (e.g., when) the (e.g., expected) latency due to a change in configuration is higher than a configured threshold, for example. Further, the WTRU (e.g., relay WTRU 102a) may take any number of the aforementioned actions in response to an indication for compensation received from a remote WTRU 102b/network. For example, the relay WTRU 102a may send a BSR for sending PDUs on the Uu link in a case where (e.g., when) receiving an indication from a remote WTRU 102b indicating inability to meet the QoS budget on the PC5 link. The relay WTRU 102a may trigger resource reselection (e.g., in Mode 2) for subsequent transmission on the PC5 link in a case where (e.g., when) receiving an indication from a network or another remote WTRU 102b, for example.

In one embodiment, the relay WTRU 102a may determine the time to trigger (TTT) for triggering the usage and/or activation of a forwarding configuration (e.g., mapping configuration at adaptation layer, configuration at IRCs/ERCs) based on detection of any number of triggering conditions. The relay WTRU 102a may send an indication to the gNB 180, containing explicit or implicit information on the Time To Trigger (TTT) associated with the forwarding configuration, for example.

The triggering conditions monitored/detected by the relay WTRU 102a may include any of the conditions described in other sections in this disclosure, including a combination of any number of the following:
Indication received from the network (e.g., gNB 180) and/or remote WTRU 102b: for example, in a case where (e.g., when) receiving indication related to remaining QoS or a priority value associated with PDU and/or IRC.
Loading at relay WTRU 102a: for example, in a case where (e.g., when) detecting that the number of PDUs in any number of buffers at IRCs and/or ERCs are above/below a buffer threshold value.
Change in adaptation layer configuration at relay WTRU 102a: for example, in a case where (e.g., when) changing the forwarding/mapping configuration at the adaptation layer or changing parameters (e.g., priority) associated with IRCs and/or ERCs.
Channel/Loading measurements: for example, in a case where (e.g., when) detecting change in channel/load conditions at previous-hop link and/or next hop link based on RSRP/RSRQ/CBR measurements.
Change in QoS: for example, in a case where (e.g., when) determining any change in information related to (e.g., expected) and/or remaining QoS (e.g., latency) in a case where (e.g., when) sending data in previous-hop link and/or next-hop link.
Change in other configurations: for example, in a case where (e.g., when) changing the DRX configuration applied at the relay WTRU 102a, where the DRX configuration may for example, be associated at different levels including any of: at a per-WTRU level, per IRC/ERC level, and/or per-resource pool/carrier level, etc.

According to embodiments, the relay WTRU 102a may send a status indication to the gNB 180, for example, for requesting to change the forwarding configuration and/or requesting resource grants on a TTT instance. The TTT may be determined such that the remaining QoS (e.g., latency) may be satisfied in a case where (e.g., when) forwarding/relaying PDUs over the next hop link (e.g., to a gNB 180 in UL or remote WTRU 102b in DL).

For example, the relay WTRU 102a may receive an indication from the remote WTRU 102b (e.g., priority value indication) indicating a change in the QoS (e.g., due to higher-than-(e.g., expected) latency and/or congestion for transmitting over the SL). The relay WTRU 102a may determine the time instance for forwarding the PDUs (e.g., expected) to be received from the remote WTRU 102b based on any number of the following:
Estimated PDU reception time at the relay WTRU 102a:
   For example, the relay WTRU 102a may determine/estimate the time for receiving the PDUs from the remote WTRU 102b based on information in the indication received from the remote WTRU 102b (e.g., change in priority, increase/decrease in latency, increase/decrease in data rate, increase/decrease in reliability, (e.g., expected) transmission time at remote WTRU 102b, remaining QoS, etc.).
Estimated PDU processing time at relay WTRU 102a:
   For example, processing time may include the estimated time for processing the PDUs in a case where (e.g., when) receiving at IRC(s), mapping the PDU from IRCs to ERCs at the adaptation layer, buffering at ERC(s), etc. According to embodiments, the processing time also may include the time for clearing the remaining data (e.g., buffered PDUs waiting to the scheduled and/or transmitted) in the IRC/ERC buffers.

The relay WTRU 102a also may determine a forwarding configuration to apply that may result in ensuring that the PDUs may be compensated (e.g., to offset the change in QoS in a case where (e.g., when) transmitting over first hop) while meeting E2E QoS in a case where (e.g., when) forwarding the PDUs. For example, the relay WTRU 102a may determine the forwarding configuration for QoS compensation based on any of the remaining QoS, default forwarding configuration applied, and/or information received from the remote WTRU 102b (e.g., in priority value indication).

The relay WTRU 102a may determine/estimate the TTT based on a combination of any number of the following:
Scheduling time: for example, time duration for receiving the triggering/activation indication from gNB 180 for triggering the forwarding configuration and/or for requesting/receiving the resource grants for forwarding the PDUs. The scheduling time may be based on information provided by network (e.g., preconfigured by network) and/or the time duration tracked by WTRU from previous instances, for example.
Time instance for forwarding the PDUs (e.g., sum of estimated PDU reception and the estimated PDU processing time at relay WTRU 102a).

The TTT may be determined by subtracting the scheduling time from the time instance for forwarding the PDUs at relay WTRU 102a, for example. The WTRU may send status indication to gNB 180 for triggering and/or activating the forwarding configuration to apply and/or for sending the resource request based on the determined TTT.

The information to be included by the relay WTRU 102a in a case where (e.g., when) sending the status indication may include information described in other sections of this disclosure, including any combination of any number of the following:
IRC/ERC Configuration Identifiers/IDs:
   For example, the relay WTRU 102a may indicate the IDs of the forwarding configuration and/or configurations applied at IRCs/ERCs. The relay WTRU 102a may indicate the IDs of the preconfigured forwarding and/or IRC/ERC configurations determined/selected by the WTRU, for example, for activation, based on detection of the triggering conditions, for example.
Request for resources:
   For example, the relay WTRU 102a may indicate information on the amount of data (e.g., number of PDUs, total payload amount, whether the number of PDUs/total payload is above/below a threshold) that is buffered at IRCs and/or ERCs. Such information may be applicable in a case where (e.g., when) sending resource request, for example.
   The resource request may be associated with and/or included in different indication/messages, such as SR, BSR, pre-emptive BSR, assistance information.
TTT/timing information:
   For example, the relay WTRU 102a may indicate the explicit TTT/timing information on in a case where (e.g., when) to start/stop the triggering and/or activation/deactivation of a forwarding configuration and/or configuration applied at IRC/ERC.
   According to embodiments, the relay WTRU 102a may implicitly indicate the timing information for triggering the activation/deactivation of a forwarding configuration and/or IRC/ERC configuration by sending the status indication at the determined TTT value.
   According to embodiments, the relay WTRU 102a may indicate the timing information (e.g., start time, end time, duration, periodicity) on in a case where (e.g., when) to use the resource grants (e.g., dynamic grant and/or configured grant) if the status indication is associated with a resource request indication (e.g., SR, BSR, pre-emptive BSR, assistance information).
   The timing information may be expressed in terms of number of symbols, slots, frames, subframes or seconds, for example, from the time instance in a case where (e.g., upon) detecting a triggering condition, for example.
QoS:
   For example, the relay WTRU 102a may indicate the determined/estimated remaining QoS (e.g., latency, throughput) and/or QoS achievable in the next-hop link (e.g., Uu link or SL).
   According to embodiments, the relay WTRU 102a may indicate the achievable data rate, achievable latency, and/or achievable reliability in a case where (e.g., when) performing transmission(s) in the next-hop link (e.g., Uu link or SL).
Forwarding configuration and/or IRC/ERC configuration(s):
   For example, the relay WTRU 102a may indicate the parameters associated with determined/selected forwarding configuration (e.g., priority values, weight values, difference/delta priority/weight values (e.g., with respect to preconfigured priority/weight values)), and/or parameters associated with IRC/ERC configurations (e.g., LCH parameters, priority).
Information on channel/load measurements made on SL and/or Uu links (e.g., RSRP, CBR).
Indication for suspension/resumption in a case where (e.g., when) suspending/resuming reception and/or transmission via any number of IRCs/ERCs.

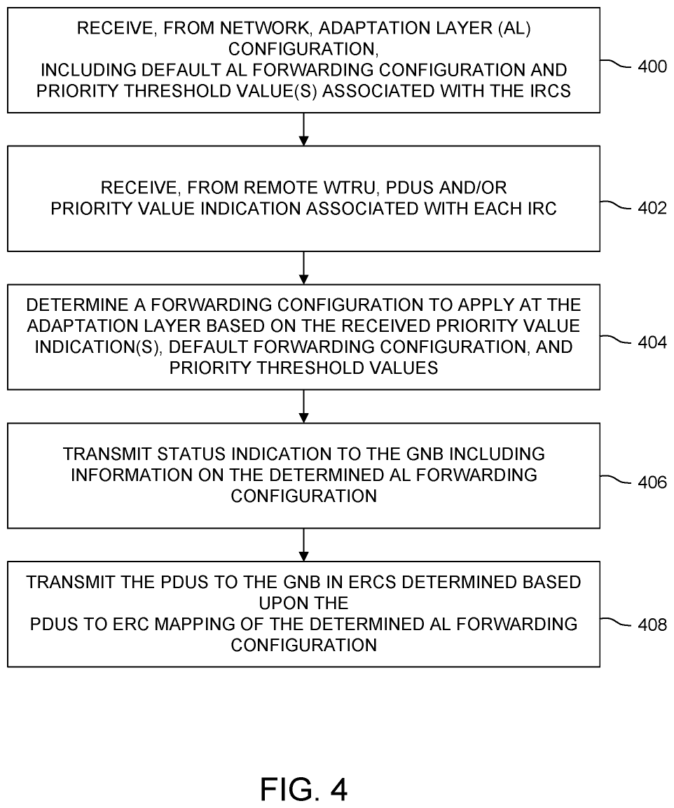

FIG. 4 is a flowchart illustrating an exemplary procedure for a relay WTRU 102a for determining and applying a forwarding configuration (e.g. priority values, ordering, weight values associated with IRCs/ERCs) at the adaptation layer in a case where (e.g., when) performing N:1 mapping (from IRCs to ERC) for satisfying the remaining QoS of received PDUs from remote WTRU(s) based on at least configured default forwarding config, priority threshold value associated with any (e.g., each) IRC, and priority value indications received from remote WTRUs.

In step 400, the relay WTRU 102a may receive from the gNB 180, an adaptation layer (AL) configuration, which may include a default AL forwarding configuration (e.g., default priority values for the configured IRCs) and any number of priority threshold values associated with the IRCs. The priority threshold values may correspond to upper/lower bounds of the priority value assigned to/associated with the IRCs. The relay WTRU 102a may change the priority values associated with the IRCs, for example, in a case where (e.g., when) revising the default AL forwarding configuration, so long the changed priority values remain within the upper/lower bounds of the priority threshold values, for example.

In step 402, the relay WTRU 102a may receive from any number of remote WTRUs, the PDUs and/or priority value indication (e.g., in SCI, SL MAC CE) associated with any (e.g., each) IRC. For example, the priority value indication may indicate whether or not to change the QoS (e.g., PDB, data rate), in a case where (e.g., when) forwarding the PDUs over the next hop link, based on the indication containing different priority values.

In step 404, the relay WTRU 102a may determine a forwarding configuration to apply at the adaptation layer based on the received priority value indication(s), default forwarding configuration, and priority threshold values. If the received priority value indication indicates that, for at least one IRC, the priority value is higher/lower than the respective priority threshold value, the relay WTRU 102a may determine and apply a revised AL forwarding configuration. The revised AL forwarding configuration may be determined such that it comprises updated priority value/weight values corresponding to the indicated IRC(s) and/or within the respective priority threshold values. In such case, the priority value/weight value may be updated such that using higher/lower values may allow to compensate for the higher latency over SL, for example. If the received indication indicates that, for all IRCs, the priority value is within the respective priority threshold values, the relay WTRU 102a may use the default AL forwarding configuration.

In step 406, the relay WTRU 102a may transmit a status indication to the gNB 180, including information on the determined AL forwarding configuration, such as whether the default or revised forwarding configuration is applied and information on the revised priority values applied at the IRCs.

In step 408, The relay WTRU 102a may transmit the PDUs to the gNB 180 in ERCs determined based in a case where (e.g., upon) the PDUs to ERC mapping of the determined AL forwarding configuration.

### 3. Example Implementation(s)

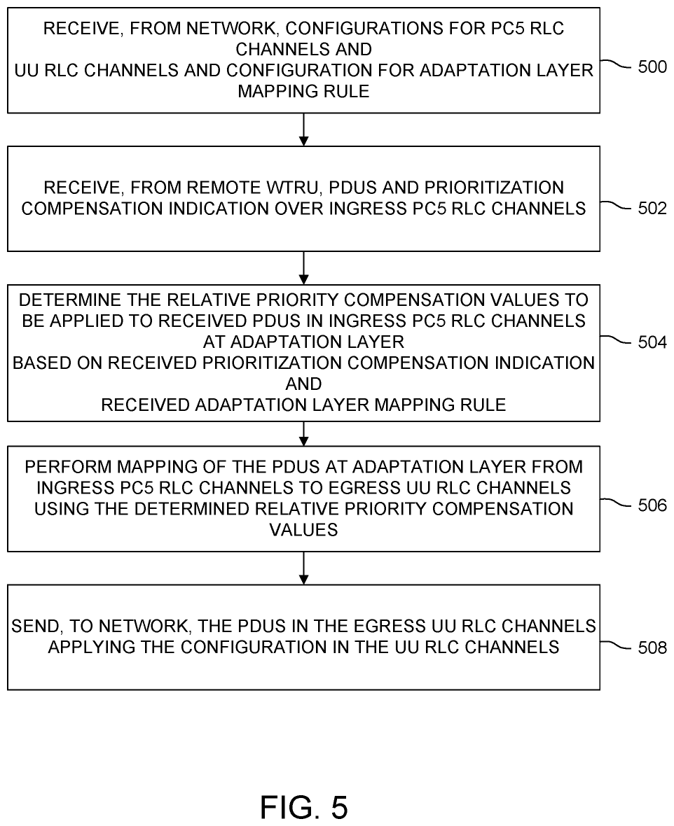

It is envisioned that the methods previously described herein may be combined in various ways. For example, referring to FIG. 5, a method of wireless communication implemented at a relay WTRU 102a begins at a first step 500 in which the WTRU receives, from a network, configurations for PC5 RLC channels and Uu RLC channels and a configuration for adaptation layer mapping rule. In this example, the WTRU may implement particular techniques for determining the mapping configuration and determining the RLC channel configuration as previously described. However, it is envisioned that the method may employ any of the additional or alternative techniques previously described for carrying out these operations, such as using any number of default configurations. Processing may proceed from step 500 to a second step 502.

At step 502, the relay WTRU 102a may receive, from a remote WTRU 102b, PDUs and a prioritization compensation indication over ingress PC5 RLC channels. In this example, the relay WTRU 102a receives a message that was transmitted by a downstream WTRU according to the methods previously described for informing remote WTRUs for ensuring uniformity in QoS. The relay WTRU 102a is the remote WTRU 102b from the perspective of the downstream WTRU. It is envisioned that the relay WTRU 102a may also transmit its own upstream messages as previously described. Processing may proceed from step 502 to a third step 504.

At step 504, the relay WTRU 102a may determine the relative priority compensation values to be applied to received PDUs in ingress PC5 RLC channels at an adaptation layer based on the received prioritization compensation indication and the received adaptation layer mapping rule. The relay WTRU 102a may determine these values as RCF values in any manner previously described, such as with reference to methods for determining the ordering of PDUs. Processing may proceed from step 504 to a fourth step 506.

At step 506, the relay WTRU 102a may perform mapping of the PDUs at an adaptation layer, from ingress PC5 RLC channels to egress Uu RLC channels, using the determined relative priority compensation values. The relay WTRU 102a may perform this mapping in any manner previously described, such as with reference to methods for determining the ordering of PDUs and as described with reference to FIG. 3. It is also envisioned that the relay WTRU 102a may trigger a resource request and/or reselection as previously described herein. Processing may proceed from step 506 to a fifth step 508.

At step 508, the relay WTRU 102a may send, to the network, the PDUs in the egress Uu RLC channels in a case where (e.g., upon) applying the configuration in the Uu RLC channels. The relay WTRU 102a may perform this transmission in any manner previously described, such as with reference to methods for determining the ordering of PDUs and as described with reference to FIG. 3.

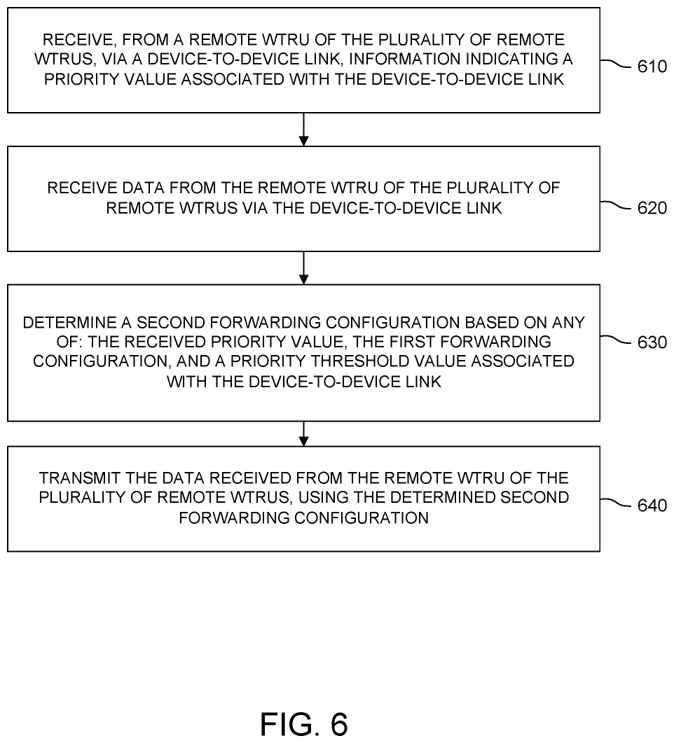

FIG. 6 is a flowchart illustrating an exemplary procedure for a relay WTRU 102a to relay data from a plurality of remote WTRUs 102b using a first forwarding configuration.

Referring to FIG. 6, the representative method may include, at block 610, receiving, from a remote WTRU of the plurality of remote WTRUs, via a device-to-device link, information indicating a priority value associated with the device-to-device link. At block 620, the relay WTRU 102a may receive data from the remote WTRU of the plurality of remote WTRUs 102b via the device-to-device link. At block 630, the relay WTRU 102a may determine a second forwarding configuration based on any of: the received priority value, the first forwarding configuration, and a priority threshold value associated with the device-to-device link. At block 640, the relay WTRU 102a may transmit the data received from the remote WTRU of the plurality of remote WTRUs 102b, using the determined second forwarding configuration.

In certain representative embodiments, the relay WTRU 102a may transmit to a network node (e.g., gNB 180), information indicating the determined second forwarding configuration.

In certain representative embodiments, the relay WTRU 102a may receive from a network node (e.g., gNB 180), the first forwarding configuration, and/or one or more priority threshold values associated respectively to one or more device-to-device link.

In certain representative embodiments, the first forwarding configuration may comprise information indicating one or more priority values associated respectively to one or more device-to-device link.

In certain representative embodiments, the data may be received by the relay WTRU 102a via an ingress channel associated with the device-to-device link, the priority value may be associated with the ingress channel, the priority threshold value may be associated with the ingress channel, and/or the received data may be transmitted by the relay WTRU 102a using the determined second forwarding configuration via an egress channel.

In certain representative embodiments, a first priority threshold value may correspond to an upper bound of the priority value associated with the device-to-device link and/or a second priority threshold value may correspond to a lower bound of the priority value associated with the device-to-device link.

In certain representative embodiments, on condition that the received priority value is: (1) higher than the first priority threshold value or (2) the received priority value is lower than the second priority threshold value, the determined second forwarding configuration is different from the first forwarding configuration.

In certain representative embodiments, on condition that the received priority value is between the first and second priority threshold values, the determined second forwarding configuration corresponds to the first forwarding configuration.

In certain representative embodiments, the relay WTRU 102a may determine a remaining quality of service for data to be received from the remote WTRU of the plurality of remote WTRUs 102b.

In certain representative embodiments, the relay WTRU 102a may determine a further priority value associated with the device-to-device link based on any of: the determined remaining quality of service of the data to be received via the device-to-device link, and measurement information associated with the device-to-device link.

In certain representative embodiments, the measurement information may correspond to a quality metric and/or load conditions of device-to-device link.

In certain representative embodiments, the relay WTRU 102a may determine the second forwarding configuration associated with the device-to-device link based on the further priority value associated with the device-to-device link.

In certain representative embodiments, the relay WTRU 102a may trigger a request for at least one of resource selection or resource reselection.

In certain representative embodiments, the data may be received from the remote WTRU of the plurality of remote WTRUs 102b via the device-to-device link, is transmitted to a further remote WTRU of the plurality of remote WTRUs 102b or to a network node (e.g., gNB 180).

In certain representative embodiments, the first forwarding configuration and/or second forwarding configuration may comprise any of: information indicating a mapping of one or more ingress channels to an egress channel; information indicating an order of protocol data units (PDUs) received from one or more ingress channels when transmitting the PDUs received via an egress channel; and information indicating a schedule of data transmission of the data received from one or more ingress channels when transmitting the data received via an egress channel.

In certain representative embodiments, the device-to-device link is a PC5 link.

In certain representative embodiments, the ingress channel and/or the egress channel is a RLC channel.

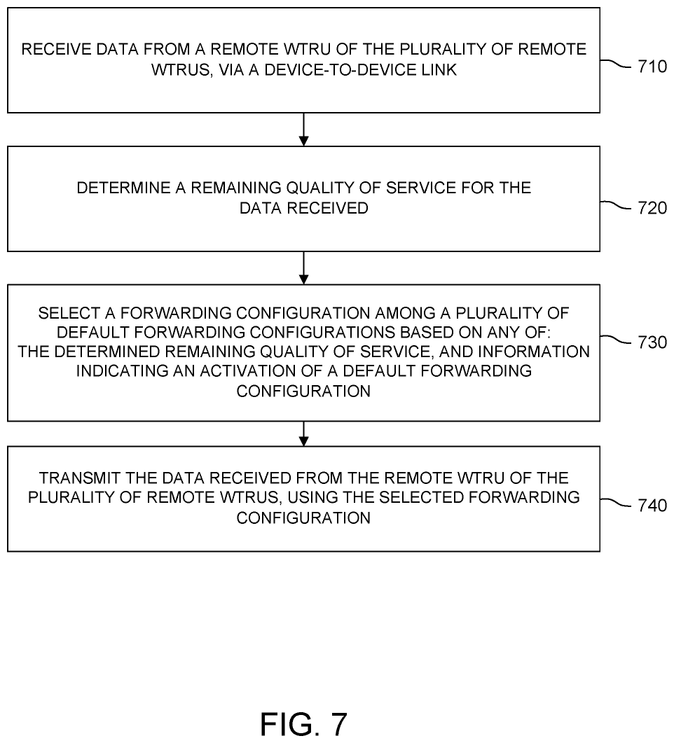

FIG. 7 is a flowchart illustrating an exemplary procedure for a relay WTRU 102a to relay data from a plurality of remote WTRUs 102b using a first forwarding configuration.

Referring to FIG. 7, the representative method may include, at block 710, receiving data from a remote WTRU of the plurality of remote WTRUs 102b, via a device-to-device link. At block 720, the relay WTRU 102a may determine a remaining quality of service for the data received. At block 730, the relay WTRU 102a may select a forwarding configuration among a plurality of default forwarding configurations based on any of: the determined remaining quality of service, and information indicating an activation of a default forwarding configuration. At block 740, the relay WTRU 102a may transmit the data received from the remote WTRU of the plurality of remote WTRUs 102b, using the selected forwarding configuration.

In certain representative embodiments, information indicating an activation of a default forwarding configuration of the plurality of default forwarding configurations may be received from a network node (e.g., gNB 180).

In certain representative embodiments, applying a default forwarding configuration of the plurality of default forwarding configurations may comprise sending an indication to one or more remote WTRUs 102b, wherein the indication controls data transmission flow over one or more device-to-device link associated respectively with one or more remote WTRUs 102b.

In certain representative embodiments, the data may be received by the relay WTRU 102a from the remote WTRU of the plurality of remote WTRUs 102b via an ingress channel associated with the device-to-device link; the priority value may be associated with the ingress channel; and the received data may be transmitted by the relay WTRU 102a using the selected forwarding configuration via an egress channel.

In certain representative embodiments, applying a default forwarding configuration of the plurality of default forwarding configurations may comprise adapting an ordering of PDUs of the data received from one or more ingress channels when transmitting the PDUs received using the selected forwarding configuration via an egress channel.

In certain representative embodiments, the data received from the remote WTRU of the plurality of remote WTRUs 102b via the device-to-device link, may be transmitted to a further remote WTRU of the plurality of remote WTRUs 102b or to a network node (e.g., gNB 180).

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein, are provided below with respect to FIGS. 1A-1E, 2 and 3.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented in a relay Wireless Transmit/Receive Unit (WTRU), the method comprising:
receiving, from a remote WTRU of a plurality of remote WTRUs, via a device-to-device link, information indicating a first priority value associated with the device-to-device link;
receiving data from the remote WTRU via the device-to-device link;
determining a first forwarding configuration based on any of: the first priority value, a second priority value associated with the device-to-device link, and a priority delta threshold value associated with the device-to-device link; and
transmitting the data from the remote WTRU using the first forwarding configuration.

2. The method of claim 1, further comprising in a preliminary step: configuring the relay WTRU with at least one of a second forwarding configuration and the second priority value associated with the device-to-device link.

3. The method of claim 2, further comprising receiving, from a network node, at least one of the second forwarding configuration and one or more priority delta threshold values associated respectively to one or more device-to-device link.

4. (canceled)

5. The method of claim 1, wherein any of:
the data is received by the relay WTRU via an ingress channel associated with the device-to-device link,
the first priority value is associated with the ingress channel,
the priority delta threshold value is associated with the ingress channel, and
the data is transmitted by the relay WTRU using the first forwarding configuration via an egress channel.

6. (canceled)

7. The method of claim 2, wherein, on condition that a delta between the first priority value and the second priority value is higher than the priority delta threshold value, the first forwarding configuration is different from a second forwarding configuration, and wherein on condition that the delta between the first priority value and the second priority value is lower than the priority delta threshold value, the first forwarding configuration corresponds to the second forwarding configuration.

8. (canceled)

9. The method of claim 1, further comprising determining a remaining quality of service for data to be received from the remote WTRU of the plurality of remote WTRUs; determining a third priority value associated with the device-to-device link based on any of: the determined remaining quality of service of the data to be received via the device-to-device link, and measurement information associated with the device-to-device link; and wherein the measurement information corresponds to at least one of a quality metric of the device-to-device link and/or one or more load conditions of the device-to-device link.

10-13. (canceled)

14. The method of claim 1, wherein the data received from the remote WTRU via the device-to-device link, is transmitted to a further remote WTRU of the plurality of remote WTRUs or to a network node.

15. The method of claim 1, wherein the first forwarding configuration and/or second forwarding configuration comprise any of:
information indicating a mapping of one or more ingress channels to an egress channel;
information indicating an order of a plurality of protocol data units (PDUs) received from one or more ingress channels when transmitting the plurality of PDUs received via an egress channel; and
information indicating a schedule of data transmission of the data received from one or more ingress channels when transmitting the data received via an egress channel.

16. The method of claim 1, wherein the device-to-device link is a PC5 link.

17. (canceled)

18. A relay wireless transmit/receive unit (WTRU), the WTRU comprising:
circuitry, including a transmitter, a receiver and a processor, configured to:
receive, from a remote WTRU of a plurality of remote WTRUs, via a device-to-device link, information indicating a first priority value associated with the device-to-device link;
receive data from the remote WTRU via the device-to-device link;
determine a first forwarding configuration based on any of: the first priority value, a second priority value associated with the device-to-device link, and a priority delta threshold value associated with the device-to-device link; and
transmit the data from the remote WTRU using the first forwarding configuration.

19. The method of claim 18, wherein the processor is configured to, in a preliminary step: configure the relay WTRU with at least one of a second forwarding configuration and the second priority value associated with the device-to-device link.

20. The method of claim 19, wherein the processor is configured to receive, from a network node, at least one of the second forwarding configuration and one or more priority delta threshold values associated respectively to one or more device-to-device link.

21. The method of claim 18, wherein any of:
the data is received by the relay WTRU via an ingress channel associated with the device-to-device link,
the first priority value is associated with the ingress channel,
the priority delta threshold value is associated with the ingress channel, and
the data is transmitted by the relay WTRU using the first forwarding configuration via an egress channel.

22. The method of claim 19, wherein, on condition that a delta between the first priority value and the second priority value is higher than the priority delta threshold value, the first forwarding configuration is different from second forwarding configuration; and
wherein on condition that the delta between the first priority value and the second priority value is lower than the priority delta threshold value, the first forwarding configuration corresponds to the second forwarding configuration.

23. The method of claim 18, wherein the processor is configured to:
determine a remaining quality of service for data to be received from the remote WTRU; and
determine a third priority value associated with the device-to-device link based on any of:
the determined remaining quality of service of the data to be received via the device-to-device link, and measurement information associated with the device-to-device link, and wherein the measurement information corresponds to at least one of a quality metric of the device-to-device link and one or more load conditions of the device-to-device link.

24. The method of claim 18, wherein the data received from the remote WTRU via the device-to-device link is transmitted to a further remote WTRU of the plurality of remote WTRUs or to a network node.

25. The method of claim 18, wherein the first forwarding configuration and/or second forwarding configuration comprise any of:
information indicating a mapping of one or more ingress channels to an egress channel;
information indicating an order of a plurality of protocol data units (PDUs) received from one or more ingress channels when transmitting the plurality of PDUs received via an egress channel; and
information indicating a schedule of data transmission of the data received from one or more ingress channels when transmitting the data received via an egress channel.

26. The method of claim 18, wherein the device-to-device link is a PC5 link.
